(19) United States
(12) Patent Application Publication
(10) Pub. No.: US 2008/0199606 A1
(43) Pub. Date: Aug. 21, 2008

(54) Composition for the Impregnation of Fibers, Fabrics and Nettings Imparting a Protective Activity Against Pests

(75) Inventors: Ulrich Karl, Grunstadt (DE); Christopher Koradin, Ludwigshafen (DE); John H. Thomas, Bridgewater, NJ (US); Hassan Oloumi-Sadeghi, Raleigh, NC (US); David G. Kuhn, Apex, NC (US)

Correspondence Address: HUTCHISON LAW GROUP PLLC, PO BOX 31686, RALEIGH, NC, 27612, US

(73) Assignee: BASF Aktiengesellschaft, Ludwigshafen (DE)

(21) Appl. No.: 11/916,202

(22) PCT Filed: May 30, 2006
(86) PCT No.: PCT/EP06/62724

§ 371 Date: Nov. 30, 2007

Related U.S. Application Data
(60) Provisional application No. 60/687,028, filed on Jun. 3, 2005.

(51) Int. Cl. B05D 5/06; A01N 37/52; A01P 7/04

(52) U.S. Cl. 427/158; 514/632; 427/157

(57) ABSTRACT

Insecticide composition for application to a non-living material, which insecticide composition comprises a mixture including at least one N-arylhydrazine derivative, and at least one polymeric binder; an impregnated non-living material comprising at least one N-arylhydrazine derivative, and at least one polymeric binder; a process for impregnation of a non-living material, a process for coating of a non-living material and the use of the insecticide composition of the present invention for impregnation of a non-living material.

The present invention relates to an insecticide composition for application to a non-living material, which insecticide composition comprises a mixture including at least one N-arylhydrazine derivative, and at least one polymeric binder; an impregnated non-living material comprising at least one N-arylhydrazine derivative, and at least one polymeric binder; a process for impregnation of a non-living material, a process for coating of a non-living material and the use of the insecticide composition of the pre-sent invention for impregnation of a non-living material.

Infectious diseases cause huge damages by debilitating or even killing humans and animals in many countries, especially in tropical countries. Many of these diseases (e.g. malaria, dengue and yellow fever, lymphatic filariasis, and leishmaniasis) are transmitted by insects. Since many medical methods like vaccination or medical treatments are either impossible or too expensive or have been rendered ineffective due to spreading resistance against drugs, efforts have been concentrated on controlling the transmitting insects. Methods to control these insects comprise treating surfaces of huts and houses, air spraying and impregnation of curtains and bednets. The latter treatment is up to now mostly done by dipping the textile material into emulsions or dispersions of insecticides or spraying them onto the nets. Since this provides only a loose adhesion of the insecticide molecules on the surface of the fibers, this treatment is not wash-permanent and has to be repeated after each washing. Studies have proven long-lasting insecticide-treated nets (LLINs) to be more reliable in preventing carrier-borne diseases in comparison with conventional nets, which have to be re-impregnated with insecticide after each washing. Experience shows, however, that washed nets are not retreated in many cases leaving them without any biological activity. WHO, UNICEF and global relief organisations therefore recommend pre-treated, long-lasting insecticide-treated nets which are wash-permanent as an effective means for the containment of deadly tropical diseases, especially malaria and dengue fever. This is not only comfortable for the user but gives him an economic advantage as well, saving the costs for the repeated impregnation. It is an ecological advantage as well, since the permanent treatment is done under controlled conditions in textile finishing plants.

WO 01/37662 discloses impregnated nettings or fabrics for insect or tick killing and/or repellent of an insect or tick comprising an insecticide and/or a repellent, and a film forming component reducing the wash off and degradation of the insecticide component from the netting or fabric by forming a water- and optionally an oil-resistant film. The film forming component preferably comprises one or more components selected from paraffin oil or wax derivatives, silicon derivatives, silicon oils or wax derivatives, and polyfluorocarbon derivatives. The netting or fabric is impregnated by adding a solution or a water emulsion of an insecticide and/or repellent and a film forming component successively (in two steps) or in one process step. According to the specification of WO 01/37662 is the insecticide and/or repellent dissolved in an organic solvent in the process for impregnation of a fabric or a netting. Preferred insecticides are according to WO 01/37662 from the group of pyrethroid compounds.

WO 03/034823 discloses an insecticide composition for application to a fabric material, which composition comprises a mixture including an insecticide, a copolymeric binder, that, after drying and while the fabric material is dry, imparts hydrophobicity to the insecticide, and a dispersing agent, that, after application of the composition to a fabric and upon wetting the fabric, reduces the hydrophobicity imparted to the insecticide by the binder to permit limited insecticide release. The copolymeric binder is prepared as a copolymer emulsion that is derived by an emulsion polymerization technique from monomers selected from at least one of the groups including a) vinyl esters of aliphatic acid having 1 to 18 carbon atoms, such as vinyl acetate and vinyl versatate; b) acrylic and methacrylic esters of an alcohol having 1 to 18 carbon atoms, such as butyl acrylate, 2-ethylhexylacrylate, and methyl acrylate; and c) mono- and di-ethylenically unsaturated hydrocarbons, such as styrene, and aliphatic diens, such as butadiene. The preferred copolymeric binder is prepared by emulsion polymerisation of two different monomers. The insecticide composition of WO 03/034823 is applied to the fabric or netting by dipping, spraying, brushing, and the like. According to the examples the insecticides have to be dissolved in organic solvents before applying the insecticide composition to a fabric material. Suitable insecticides are according to WO 03/034823 pyrethroids and non-pyrethroids such as Carbosulphan.

U.S. Pat. No. 5,631,072 discloses the manufacture of fabric intended to be made into washable garments, more specifically to the placement of an insecticide such as permethrin in the fabric by impregnation with polymeric binders and a cross-linking agent, or by surface coating with a polymeric binder and a thickening agent to improve the efficiency as an insect repellent and retention of the permethrin in the fabric as an effective insecticide through successive washings of the garments. According to the examples, suitable binders are acrylic binders and polyvinylacetate binders, which are not further specified. The amount of insecticide in the solutions for impregnation of the fabric is very high (1250 mg insecticide per m²). As insecticide permethrin, a synthetic pyrethroid, is used.

Typical problems arising with the use of presently available public health pest control agents such as pyrethroids are e.g. resistance of pests or unfavorable environmental or toxicological properties. Another problem encountered concerns the need to have available public health pest control agents which are effective against a broad spectrum of public health pests. Accordingly, there is a need to provide a new and improved ways of public health pest control It is an object of the present invention to provide an insecticide composition (in the following also: composition) for application to a non-living material, wherein the public health pest control agent is not washed out and in which the bioavailability of the public health pest control agent for killing insects is maintained after multiple washes or multiple contacts with water. It is a further object of the present invention to provide a composition comprising alternative public health pest control agents, preferably exhibiting an enhanced pesticidal spectrum of action.

It is a further object of the present invention to provide impregnated and/or coated non-living materials comprising alternative public health pest control agents which are not washed out and in which the bioavailability of the public health pest control agent for killing insects is maintained after multiple washes or multiple contacts with water.

According to the present invention there is provided an insecticide composition for application to a non-living material which composition comprises a mixture including
a) at least one arylhydrazine derivative of formula I as component A,

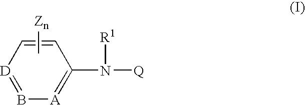

wherein
A is C—R² or N;
B is C—R³ or N;
D is C—R⁴ or N;
with the proviso that at least one of A, B or D must be other than N;
Z is halogen, CN, NO₂, C₁-C₆-alkyl, C₁-C₆-haloalkyl, C₁-C₆-alkoxy or C₁-C₆-haloalkoxy;
n is an integer of 0, 1 or 2;
Q is

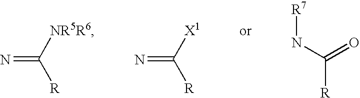

wherein
R is
hydrogen;
C₁-C₁₀-alkyl, optionally substituted with one or more halogens; C₃-C₆-cycloalkyl; C₁-C₄-alkoxy; C₁-C₄-haloalkoxy; (C₁-C₄-alkyl)SOₓ; (C₁-C₄-haloalkyl)SOₓ; phenyl, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂ or CN groups; phenoxy, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂ or CN groups; C₃-C₁₂-cycloalkyl, optionally substituted with one or more halogens, C₁-C₆-alkyl, C₁-C₆-haloalkyl, C₁-C₄-alkoxy, C₁-C₄-haloalkoxy, (C₁-C₄-alkyl)SOₓ, (C1-C4-haloalkyl)SOₓ; phenyl, optionally substituted with one to three halogen, C₁-C₄-alkyl, C₁-C₄-haloalkyl, C₁-C₄-alkoxy, C₁-C₄-haloalkoxy, NO₂ or CN groups; phenoxy, optionally substituted with one to three halogen, C₁-C₄-alkyl, C₁-C₄-haloalkyl, C₁-C₄-alkoxy, C₁-C₄-haloalkoxy, NO₂ or CN groups;
or
phenyl, optionally substituted with one or more halogens, C₁-C₄-alkyl, C₁-C₄-haloalkyl, C₁-C₄-alkoxy, C₁-C₄-haloalkoxy, NO₂ or CN groups;
or
CR¹⁷R¹⁸R¹⁹;
R¹⁷ and R¹⁸ are each independently C₁-C₆-alkyl, C₃-C₆-alkenyl, C₃-C₆-alkynyl, or C₃-C₆-cycloalkyl which may be substituted with 1 to 3 halogen atoms;
R¹⁹ is hydrogen or C₁-C₆-alkyl;
R¹ and R⁷ are each independently hydrogen or C₁-C₄-alkyl;
R⁵ and R⁶ are each independently hydrogen;
C₁-C₁₀-alkyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂ or CN groups;
phenyl, optionally substituted with one or more halogen, C₁-C₄-alkyl, C₁-C₄-haloalkyl, C₁-C₄-alkoxy, C₁-C₄-haloalkoxy, NO₂ or CN groups; pyridyl, optionally substituted with one or more halogen, C₁-C₄-alkyl, C₁-C₄-haloalkyl, C₁-C₄-alkoxy, C₁-C₄-haloalkoxy, NO₂ or CN groups;
C₃-C₁₀-alkenyl, optionally substituted with one or more halogen, hydroxy,
C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂ or CN groups;
phenyl, optionally substituted with one or more halogen, C₁-C₄-alkyl, C₁-C₄-haloalkyl, C₁-C₄-alkoxy, C₁-C₄-haloalkoxy, NO₂ or CN groups;
pyridyl, optionally substituted with one or more halogen, C₁-C₄-alkyl, C₁-C₄-haloalkyl, C₁-C₄-alkoxy, C₁-C₄-haloalkoxy, NO₂ or CN groups; C₃-C₁₀-alkynyl, optionally substituted with one or more halogen, hydroxy,
C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂ or CN groups;
phenyl, optionally substituted with one or more halogen, C₁-C₄-alkyl, C₁-C₄-haloalkyl, C₁-C₄-alkoxy, C₁-C₄-haloalkoxy, NO₂ or CN groups; pyridyl, optionally substituted with one or more halogen, C₁-C₄-alkyl, C₁-C₄-haloalkyl, C₁-C₄-alkoxy, C₁-C₄-haloalkoxy, NO₂ or CN groups;
C₃-C₁₂-cycloalkyl, optionally substituted with one or more halogen, hydroxy,
C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂ or CN groups;
phenyl, optionally substituted with one or more halogen, C₁-C₄-alkyl, C₁-C₄-haloalkyl, C₁-C₄-alkoxy, C₁-C₄-haloalkoxy, NO₂ or CN groups;
pyridyl, optionally substituted with one or more halogen, C₁-C₄-alkyl, C₁-C₄-haloalkyl, C₁-C₄-alkoxy, C₁-C₄-haloalkoxy, NO₂ or CN groups;
R⁵ and R⁶ may be taken together to form a ring represented by the structure

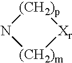

R², R³ and R⁴ are each independently hydrogen, halogen, CN, NO₂, (C₁-C₄-alkyl)SOₓ, (C₁-C₄-haloalkyl)SOₓ, C₁-C₆-alkyl, C₁-C₆-haloalkyl, C₁-C₆-alkoxy or C₁-C₆-haloalkoxy;
R⁸, R⁹ and R¹⁰ are each independently hydrogen or C₁-C₄-alkyl;
R¹¹ is NR¹³R¹⁴,

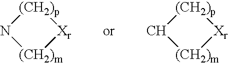

R¹² is

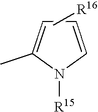

R¹³, R¹⁴, R¹⁵ and R¹⁶ are each independently hydrogen or C₁-C₄-alkyl;
X is O, S or NR¹⁵;
X¹ is chlorine, bromine or fluorine;
r is an integer of 0 or 1;
p and m are each independently an integer of 0, 1, 2 or 3, with the proviso that only one of p, m or r can be 0 and with the further proviso that the sum of p+m+r must be 4, 5 or 6;
x is an integer of 0, 1 or 2; or
the enantiomers or the salts thereof;
b) at least one polymeric binder, as component B.

The N-arylhydrazine derivatives of formula I of the insecticide compositions of the pre-sent invention are known from and can be prepared according to preparation methods described or referenced in EP-A 604 798. This document relates to plant protection in the agricultural field and discloses the insecticidal and acaricidal activity of compounds of formula I and other compounds against crop pests of the Coleoptera, Lepidoptera and Acarina orders.

Further, the use of the N-arylhydrazine derivatives of formula I for combating non-crop pests is disclosed in application PCT/EP/04/013687 having the title “The use of N-arylhydrazine derivatives for combating pests” which has been filed on Dec. 2, 2004, which is fully incorporated by reference.

Activity of a compound against pests for plant protection in the agricultural field, that is, against crop pests, does not generally suggest activity of that compound against public health pests. Crop pest control always is a part of plant protection. Public health pest control, on the contrary, relates to protection of non-living organic materials, or hygiene and disease prevention.

It has now been found that a certain group of N-arylhydrazines, namely the compounds of formula I, exhibit broad spectrum activity against public health pests. It has further been found that insecticide compositions comprising component A (at least one N-arylhydrazine derivative of formula I) as well as component B (at least one polymeric binder) provide a very good wash resistance while permitting a continuous release of the N-arylhydrazine derivative at a controlled rate.

The insecticide composition of the present invention may be in form of a solid or an aqueous formulation, wherein the aqueous formulation is preferred.

The insecticide composition of the present application provides wash resistance while permitting continuous release of the N-arylhydrazine derivative at a controlled rate, in order to provide the required bioavailability of the N-arylhydrazine derivative. Further, the insecticide emission to the environment is decreased by using the composition of the present invention which is applied to a non-living material.

In the context of the present invention the non-living material is preferably a textile material or plastics material selected from the group consisting of yarn, fibers, fabric, knit-goods, nonwovens, netting material, foils, tarpaulins and coating compositions. The netting material may be prepared by any method known in the art, for example by circular knitting or warp knitting, or by sewing parts of a netting to obtain the desired nettings.

The textile material or plastics material may be made form a variety of natural and synthetic fibers, also as textile blends in woven or non-woven form, as knit goods, yarns or fibers. Natural fibers are for example cotton, wool, silk, jute or hamp. Synthetic fibers are for example polyamides, polyesters, polyacryl nitrites, polyolefines, for example polypropylene or polyethylene, Teflon, and mixtures of fibers, for example mixtures of synthetic and natural fibers. Polyamides, polyolefins and polyesters are preferred. Polyethylene terephthalate is especially preferred.

According to the present invention the term non-living material also discloses non-textile substrates such as coating compositions, leathers, synthetic adaptions of leather, flocked fabrics, sheetings, foils and packaging material.

Further, the term non-living material discloses cellulose-containing materials e.g. cotton materials such as garment or cotton nets and also wooden materials such as houses, trees, board fences, or sleepers and also paper.

Furthermore, the term non-living material also discloses protective window and closet gratings or grills made from suitable metals.

Preferably, the non-living material is a textile material or plastics material as mentioned above.

Most preferred are nettings made from polyester, especially polyethylene terephthalate. In a further preferred embodiment the non-living material is a cellulose containing non-living material.

The insecticide composition of the present invention comprises in general 0.001 to 95% by weight preferably 0.1 to 45% by weight, more preferably 0.5 to 30% by weight, most preferably 1 to 25% by weight, based on the weight of the insecticide composition, of at least one N-arylhydrazine derivative of formula I.

The insecticide composition preferably comprises the following components, based on the solids content of the composition
a) 0.1 to 45% by weight, preferably 0.5 to 30% by weight, more preferably 1 to 25% by weight of at least one N-arylhydrazine derivative of formula I (component A), and
b) 55 to 99% by weight, preferably 70 to 98% by weight, more preferably 75 to 90 by weight of at least one polymeric binder (component B),
   wherein the sum of the components is 100% by weight of solids content of the insecticide composition.

In a further preferred embodiment the insecticide composition comprises the following components, based on the solids content of the composition
a) 20 to 70% by weight, preferably 25 to 65% by weight, more preferably 30 to 65% by weight of at least one N-arylhydrazine derivative of formula I (component A), and
b) 30 to 80% by weight, preferably 35 to 75% by weight, more preferably 35 to 70 by weight of at least one polymeric binder (component B),
   wherein the sum of the components is 100% by weight of solids content of the insecticide composition.

The aim of the invention is to control and/or to combat a variety of pests, such as ticks, cockroaches, bed bugs, mites, fleas, lice, leeches, houseflies, mosquitoes, termites, ants, moths, spiders, grasshoppers, crickets, silverfish, also in form of their larvae and eggs, and other flying and crawling insects, and mollusks, e.g. snails and slugs, and rodents, e.g. rats and mice.

The insecticide compositions of the present invention are useful for controlling and/or combating public health pests such as pests of the classes Chilopoda and Diplopoda and of the orders Isoptera, Diptera, Blattaria (Blattodea), Dermaptera, Hemiptera, Hymenoptera, Orthoptera, Siphonaptera, Thysanura, Phthiraptera, Araneida and Acarina.

The insecticide compositions of the present invention are particularly useful for the control of pests from the orders Diptera, Hemiptera, Hymenoptera, Acarina and Siphonaptera.

In particular, the insecticide compositions of the present invention are useful for the control of Diptera (Culicidae, Simuliidae, Ceratopogonidae, Tabanidae, Muscidae, Calliphoridae, Oestridae, Sarcophagidae, Hippoboscidae), Siphonaptera (Pulicidae, Rhopalopsyllidae, Ceratophyllidae) and Acarina (Ixodidae, Argasidae, Nuttalliellidae).

In a further preferred embodiment of the present invention the insecticide compositions of the present invention are useful for combating pests of the Diptera order, especially flies and mosquitoes.

Moreover, the insecticide compositions of the present invention are especially useful for combating pests of the Siphonaptera.

In a further preferred embodiment of the present invention the insecticide compositions of the present invention are useful for combating pests of the Acarina, especially the Ixodida order, especially flies and mosquitoes.

The compositions of the present invention comprising compounds of the formula I are especially suitable for efficiently controlling and/or combating the following pests:

centipedes (Chilopoda), e.g. Scutigera coleoptrata,
millipedes (Diplopoda), e.g. Narceus spp.,
spiders (Araneida), e.g. Latrodectus mactans, and Loxosceles recluse,
scabies (Acaridida): e.g. sarcoptes sp,
ticks and parasitic mites (Parasitiformes): ticks (Ixodida), e.g. Ixodes scapularis, Ixodes holocyclus, Ixodes pacificus, Rhiphicephalus sanguineus, Dermacentor andersoni, Dermacentor variabilis, Amblyomma americanum, Ambryomma maculatum, Ornithodorus hermsi, Ornithodorus turicata and parasitic mites (Mesostigmata), e.g. Ornithonyssus bacoti and Dermanyssus gallinae,
termites (Isoptera), e.g. Calotermes flavicollis, Leucotermes flavipes, Heterotermes aureus, Reticuitermes flavipes, Reticulitermes virginicus, Reticuitermes lucifugus, Termes natalensis, and Coptotermes formosanus,
cockroaches (Blattaria-Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis,
flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Chrysomya bezziana, Chrysomya hominivorax, Chrysomya macellaria, Chrysops discalis, Chrysops silacea, Chrysops atlanticus, Cochliomyla hominivorax, Cordylobia anthropophaga, Culicoides furens, Culex pipiens, Culex nigripalpus, Culex quinquefasciatus, Culex tarsalis, Culiseta inornata, Culiseta melanura, Dermatobia hominis, Fannia canicularis, Gasterophilus intestinalis, Glossina morsitans, Glossina palpalis, Glossina fuscipes, Glossina tachinoides, Haematobia irritans, Haplodiplosis equestris, Hippelates spp., Hypoderma lineata, Leptoconops torrens, Lucilia caprina, Lucilia cuprina, Lucilia sericata, Lycoria pectoralis, Mansonia spp., Musca domestica, Muscina stabulans, Oestrus ovis, Phlebotomus argentipes, Psorophora columbliae, Psorophora discolor, Prosimulium mixtum, Sarcophaga haemorrhoidalis, Sarcophaga sp., Simulium vittatum, Stomoxys calcitrans, Tabanus bovinus, Tabanus atratus, Tabanus lineola, and Tabanus similis,
Earwigs (Dermaptera), e.g. forficula auricularia,
true bugs (Hemiptera), e.g. Cimex lectularius, Cimex hemipterus, Reduvius senilis, Triatoma spp., Rhodnius prolixus, and Arilus critatus,
ants, bees, wasps, sawflies (Hymenoptera), e.g. Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex californicus, Dasymutilla occidentalis, Bombus spp. Vespula squamosa, Paravespula vulgaris, Paravespula pennsylvanica, Paravespula germanica, Dolichovespula maculata, Vespa crabro, Polistes rubiginosa, Camponotus floridanus, and Linepithema humile,
crickets, grasshoppers, locusts (Orthoptera), e.g. Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus itallcus, Chortolcetes terminifera, and Locustana pardalina,
fleas (Siphonaptera), e.g. Ctenocephalides felis, Ctenocephalides canis, Xenopsylla cheopis, Pulex irritans, Tunga penetrans, and Nosopsyllus fasciatus,
silverfish, firebrat (Thysanura), e.g. Lepisma saccharina and Thermobia domestica, lice (Phthiraptera), e.g. Pediculus humanus capitis, Pediculus humanus corporis, Pthirus pubis, Haematopinus eurysternus, Haematopinus suis, Linognathus vitul, Bovicola bovis, Menopon gallinae, Menacanthus stramineus and Solenopotes capillatus.

The non-living material may be a textile material or plastics material in form of coverings, for example bedclothes, mattresses, pillows, duvets, cushions, curtains, wall coverings, carpeting and window, cupboard and door screens. Further typical textile materials or plastics materials are geotextiles, tents, inner soles of shoes, garments, such as socks, trousers, shirts, i.e. preferably garments, e.g. uniforms, used in body areas exposed to insecticide bites and the like as well as horse blankets. The nettings are for example used as bed nets for example mosquito nets, or for covering or as nets in agriculture and viniculture. Other applications are movable fences for the protection of humans and animals against air-borne low-flying insects. Fabrics or nettings may be used for packages, wrapping sacks, containers for food, seeds and feed thus protecting the material from attack by insects but avoiding direct contact with the insecticide-treated nets or fabrics.

Treated foils or tarpaulins can be used on all human premises which are permanently or temporarily inhabited such as refugee camps.

It is further possible to use the treated nettings in dwellings having mud walls. A treated netting is pressed into a fresh, wet wall mud before it dries. The mud will ooze into the holes in the net but the yarn of the net will not be covered. When this wall covering is dried the insecticide and/or repellent of the treated net is slowly released and can repel or kill pests that come into contact with the wall.

Further, the non-living material may be in the form of cellulose-containing materials e.g. wooden materials such as houses, trees, board fences, or sleepers and also paper; and also construction materials, furniture, leathers, animal, plant and synthetic fibers, vinyl articles, electric wires and cables.

The insecticide composition of the present invention is particularly suitable for application to polyester nettings as used for mosquito nets.

The insecticide composition of the present invention may be applied to the non-living material, for example to textile material or plastics material, before their formation into the desired products, i.e. while still a yarn or in sheet form, or after formation of the desired products.

### N-arylhydrazine Derivative (Component A)

The at least N-arylhydrazine derivative is at least one N-arylhydrazine derivative of formula I

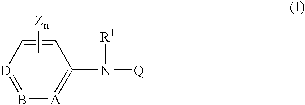

wherein

### A is C—R² or N;

### B is C—R³ or N;

### D is C—R⁴ or N;

with the proviso that at least one of A, B or D must be other than N;
Z is halogen, CN, NO₂, C₁-C₆-alkyl, C₁-C₆-haloalkyl, C₁-C₆-alkoxy or C₁-C₆-haloalkoxy;
n is an integer of 0, 1 or 2;

### Q is

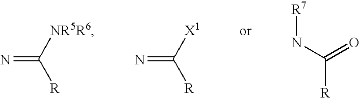

wherein

### R is

hydrogen;
C₁-C₁₀-alkyl, optionally substituted with one or more halogens; C₃-C₆-cycloalkyl; C₁-C₄-alkoxy; C₁-C₄-haloalkoxy; (C₁-C₄-alkyl)SOₓ; (C₁-C₄-haloalkyl)SOₓ; phenyl, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂ or CN groups; phenoxy, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ), NO₂ or CN groups;
C₃-C₁₂-cycloalkyl, optionally substituted with one or more halogens, C₁-C₆-alkyl, C₁-C₆-haloalkyl, C₁-C₄-alkoxy, C₁-C₄-haloalkoxy, (C₁-C₄-alkyl)SOₓ, (C₁-C₄-haloalkyl)SOₓ;
phenyl, optionally substituted with one to three halogen, C₁-C₄-alkyl, C₁-C₄-haloalkyl, C₁-C₄-alkoxy, C₁-C₄-haloalkoxy, NO₂ or CN groups; phenoxy, optionally substituted with one to three halogen, C₁-C₄-alkyl, C₁-C₄-haloalkyl, C₁-C₄-alkoxy, C₁-C₄-haloalkoxy, NO₂ or CN groups;
or
phenyl, optionally substituted with one or more halogens, C₁-C₄-alkyl, C₁-C₄-haloalkyl, C₁-C₄-alkoxy, C₁-C₄-haloalkoxy, NO₂ or CN groups;
or

### CR¹⁷R¹⁸R¹⁹;

R¹⁷ and R¹⁸ are each independently C₁-C₆-alkyl, C₃-C₆-alkenyl, C₃-C₆-alkynyl, or C₃-C₆-cycloalkyl which may be substituted with 1 to 3 halogen atoms;
R¹⁹ is hydrogen or C₁-C₆-alkyl;
R¹ and R⁷ are each independently hydrogen or C₁-C₄-alkyl;
R⁵ and R⁶ are each independently hydrogen;
C₁-C₁₀-alkyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂ or CN groups;
phenyl, optionally substituted with one or more halogen, C₁-C₄-alkyl, C₁-C₄-haloalkyl, C₁-C₄-alkoxy, C₁-C₄-haloalkoxy, NO₂ or CN groups;
pyridyl, optionally substituted with one or more halogen, C₁-C₄-alkyl, C₁-C₄-haloalkyl, C₁-C₄-alkoxy, C₁-C₄-haloalkoxy, NO₂ or CN groups;
C₃-C₁₀-alkenyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂ or CN groups;
phenyl, optionally substituted with one or more halogen, C₁-C₄-alkyl, C₁-C₄-haloalkyl, C₁-C₄-alkoxy, C₁-C₄-haloalkoxy, NO₂ or CN groups;
pyridyl, optionally substituted with one or more halogen, C₁-C₄-alkyl, C₁-C₄-haloalkyl, C₁-C₄-alkoxy, C₁-C₄-haloalkoxy, NO₂ or CN groups;
C₃-C₁₀-alkynyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂ or CN groups;
phenyl, optionally substituted with one or more halogen, C₁-C₄-alkyl, C₁-C₄-haloalkyl, C₁-C₄-alkoxy, C₁-C₄-haloalkoxy, NO₂ or CN groups;
pyridyl, optionally substituted with one or more halogen, C₁-C₄-alkyl, C₁-C₄-haloalkyl, C₁-C₄-alkoxy, C₁-C₄-haloalkoxy, NO₂ or CN groups;
C₃-C₁₂-cycloalkyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂ or CN groups;
phenyl, optionally substituted with one or more halogen, C₁-C₄-alkyl, C₁-C₄-haloalkyl, C₁-C₄-alkoxy, C₁-C₄-haloalkoxy, NO₂ or CN groups;
pyridyl, optionally substituted with one or more halogen, C₁-C₄-alkyl, C₁-C₄-haloalkyl, C₁-C₄-alkoxy, C₁-C₄-haloalkoxy, NO₂ or CN groups;
R⁵ and R⁶ may be taken together to form a ring represented by the structure

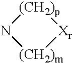

R², R³ and R⁴ are each independently hydrogen, halogen, CN, NO₂, (C₁-C₄-alkyl)SOₓ, (C₁-C₄-haloalkyl)SOₓ, C₁-C₆-alkyl, C₁-C₆-haloalkyl, C₁-C₆-alkoxy or C₁-C₆-haloalkoxy;
R⁸, R⁹ and R¹⁰ are each independently hydrogen or C₁-C₄-alkyl;

### R¹¹ is NR¹³R¹⁴,

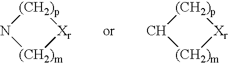

### R¹² is

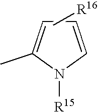

R¹³, R¹⁴, R¹⁵ and R¹⁶ are each independently hydrogen or C₁-C₄-alkyl;

### X is O, S or NR¹⁵;

X¹ is chlorine, bromine or fluorine;
r is an integer of 0 or 1;
p and m are each independently an integer of 0, 1, 2 or 3, with the proviso that only one of p, m or r can be 0 and with the further proviso that the sum of p+m+r must be 4, 5 or 6;
x is an integer of 0, 1 or 2; or
the enantiomers or the salts thereof.

In a preferred embodiment Q in formula I is

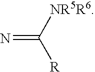

More preferably, the least one N-arylhydrazine derivative is a compound of formula Ia

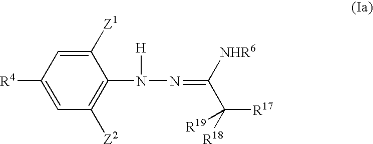

wherein
R⁴ is chlorine or trifluoromethyl;
Z¹ and Z² are each independently chlorine or bromine;
R⁶ is C₁-C₆-alkyl, C₃-C₆-alkenyl, C₃-C₆-alkynyl, or C₃-C₆-cycloalkyl which may be substituted with 1 to 3 halogen atoms, or C₂-C₄-alkyl which is substituted by C₁-C₄-alkoxy;
R¹⁷ and R¹⁸ are each independently C₁-C₆-alkyl, C₃-C₆-alkenyl, C₃-C₆-alkynyl, or C₃-C₆-cycloalkyl which may be substituted with 1 to 3 halogen atoms;
R¹⁹ is hydrogen or C₁-C₆-alkyl; or enantiomers or salts thereof.

In the definition of formula I and formula Ia shown above, the substituents have the following meanings:

“Halogen” will be taken to mean fluoro, chloro, bromo and iodo.

The term “alkyl” as used herein refers to a branched or unbranched saturated hydrocarbon group having 1 to 4 or 6 carbon atoms, especially C₁-C₆-alkyl such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl.

“Alkoxy” refers to a straight-chain or branched alkyl group having 1 to 4 carbon atoms (methyl, ethyl, propyl, 1-methylethyl, butyl, 1-methylpropyl, 2-methylpropyl, 1,1-dimethylethyl) bonded through an oxygen linkage, at any bond in the alkyl group. Examples include methoxy, ethoxy, propoxy, and isopropoxy.

“Cycloalkyl” refers to a monocyclic 3- to 6-membered saturated carbon atom ring, i.e. cyclopropyl, cyclobutyl, cyclopentyl, and cyclohexyl.

With respect to the intended use of the compounds of formula I, particular preference is given to the following meanings of the substituents, in each case on their own or in combination:

Preference is given to compounds of formula I wherein R⁴ is trifluoromethyl.

Preference is further given to compounds of formula I wherein Z¹ and Z² are both chlorine.

Moreover, preferred are compounds of formula I wherein R⁶ is C₁-C₆-alkyl, especially ethyl.

Preference is further given to compounds of formula I wherein R¹⁷ and R¹⁸ are both methyl.

Moreover, preferred are compounds of formula I wherein R¹⁷ and R¹⁸ form a cyclopropyl ring which is unsubstituted or substituted by 1 to 3 halogen atoms, especially chlorine and bromine.

Moreover, particularly preferred are compounds of formula I wherein R¹⁷ and R¹⁸ form a cyclopropyl ring which is substituted by 2 halogen atoms.

Moreover, particularly preferred are compounds of formula I wherein R¹⁷ and R¹⁸ form a cyclopropyl ring which is substituted by 2 chlorine atoms.

Particularly preferred are compounds of formula I wherein R¹⁷ and R¹⁸ form a 2,2-dichlorocyclopropyl ring.

Preference is further given to compounds of formula I wherein R¹⁹ is C₁-C₆ alkyl, especially methyl.

Particularly preferred are compounds of formula I wherein R¹⁷, R¹⁸ and R¹⁹ are all methyl.

Moreover, particularly preferred are compounds of formula I wherein R¹⁷, R¹⁸ and R¹⁹ form a moiety 1-methyl-2,2-dichlorocyclopropyl.

Preference is further given to compounds of formula I wherein

R⁴ is trifluoromethyl;
Z¹ and Z² are each independently chlorine or bromine;
R⁶ is C₁-C₆-alkyl;
R¹⁷ and R¹⁸ are C₁-C₆-alkyl or may be taken together to form C₃-C₆-cycloalkyl which is substituted by 1 to 2 halogen atoms;
R¹⁹ is C₁-C₆-alkyl;
or the enantiomers or salts thereof.

Particular preference is given to N-ethyl-2,2-dimethylpropionamide-2-(2,6-dichloro-α,α,α-trifluoro-p-tolyl)hydrazone and N-ethyl-2,2-dichloro-1-methylcyclopropane-carboxamide-2-(2,6-dichloro-α,α,α-trifluoro-p-tolyl)hydrazone.

Furthermore, particular preference with respect to the use in the present invention is given to the compound of formula Ia-I (N-ethyl-2,2-dimethylpropionamide-2-(2,6-dichloro-α,α,α-trifluoro-p-tolyl)-hydrazone):

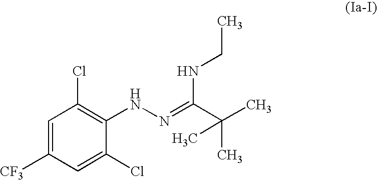

Moreover, particular preference with respect to the use in the present invention is given to the compound of formula Ia-II (N-Ethyl-2,2-dichloro-1-methylcyclo-propanecarboxamide-2-(2,6-dichloro-α,α,α-tri-fluoro-p-tolyl)hydrazone):

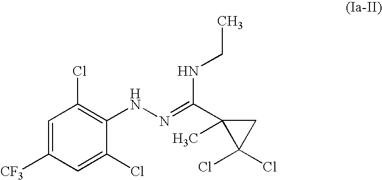

With respect to their use, particular preference is given to the compounds Ia-A compiled in the tables below. Moreover, the groups mentioned for a substituent in the tables are on their own, independently of the combination in which they are mentioned, a particularly preferred embodiment of the substituent in question.

With respect to their use, particular preference is also given to the hydrochloric acid, maleic acid, dimaleic acid, fumaric acid, difumaric acid, methane sulfenic acid, methane sulfonic acid, and succinic acid adducts of the compounds of the tables below.

TABLE A

| | |
|---|---|
| | (Ia-A) |
| 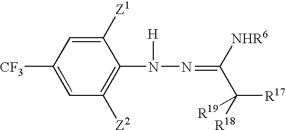 | |

| No. | R⁶ | R¹⁷ | R¹⁸ | R¹⁹ | Z¹ | Z² |
|---|---|---|---|---|---|---|
| A-1 | CH₃ | 2,2-dichlorocyclopropyl | | H | Cl | Cl |
| A-2 | CH₃ | 2,2-dibromocyclopropyl | | H | Cl | Cl |
| A-3 | CH₃ | CH₃ | CH₃ | CH₃ | Cl | Cl |
| A-4 | CH₃ | CH₂CH₃ | CH₃ | CH₃ | Cl | Cl |
| A-5 | CH₃ | 2,2-dichlorocyclopropyl | | CH₃ | Cl | Cl |
| A-6 | CH₃ | 2,2-dibromocyclopropyl | | CH₃ | Cl | Cl |
| A-7 | CH₃ | 2,2-dichlorocyclopropyl | | H | Br | Br |
| A-8 | CH₃ | 2,2-dibromocyclopropyl | | H | Br | Br |
| A-9 | CH₃ | CH₃ | CH₃ | CH₃ | Br | Br |
| A-10 | CH₃ | CH₂CH₃ | CH₃ | CH₃ | Br | Br |
| A-11 | CH₃ | 2,2-dichlorocyclopropyl | | CH₃ | Br | Br |
| A-12 | CH₃ | 2,2-dibromocyclopropyl | | CH₃ | Br | Br |
| A-13 | CH₂CH₃ | 2,2-dichlorocyclopropyl | | H | Cl | Cl |
| A-14 | CH₂CH₃ | 2,2-dibromocyclopropyl | | H | Cl | Cl |
| A-15 | CH₂CH₃ | CH₃ | CH₃ | CH₃ | Cl | Cl |
| A-16 | CH₂CH₃ | CH₂CH₃ | CH₃ | CH₃ | Cl | Cl |
| A-17 | CH₂CH₃ | 2,2-dichlorocyclopropyl | | CH₃ | Cl | Cl |
| A-18 | CH₂CH₃ | 2,2-dibromocyclopropyl | | CH₃ | Cl | Cl |
| A-19 | CH₂CH₃ | 2,2-dichlorocyclopropyl | | H | Br | Br |
| A-20 | CH₂CH₃ | 2,2-dibromocyclopropyl | | H | Br | Br |
| A-21 | CH₂CH₃ | CH₃ | CH₃ | CH₃ | Br | Br |
| A-22 | CH₂CH₃ | CH₂CH₃ | CH₃ | CH₃ | Br | Br |
| A-23 | CH₂CH₃ | 2,2-dichlorocyclopropyl | | CH₃ | Br | Br |
| A-24 | CH₂CH₃ | 2,2-dibromocyclopropyl | | CH₃ | Br | Br |
| A-25 | CH₂CH₂CH₃ | 2,2-dichlorocyclopropyl | | H | Cl | Cl |
| A-26 | CH₂CH₂CH₃ | 2,2-dibromocyclopropyl | | H | Cl | Cl |
| A-27 | CH₂CH₂CH₃ | CH₃ | CH₃ | CH₃ | Cl | Cl |
| A-28 | CH₂CH₂CH₃ | CH₂CH₃ | CH₃ | CH₃ | Cl | Cl |
| A-29 | CH₂CH₂CH₃ | 2,2-dichlorocyclopropyl | | CH₃ | Cl | Cl |
| A-30 | CH₂CH₂CH₃ | 2,2-dibromocyclopropyl | | CH₃ | Cl | Cl |
| A-31 | CH₂CH₂CH₃ | 2,2-dichlorocyclopropyl | | H | Br | Br |
| A-32 | CH₂CH₂CH₃ | 2,2-dibromocyclopropyl | | H | Br | Br |
| A-33 | CH₂CH₂CH₃ | CH₃ | CH₃ | CH₃ | Br | Br |

The N-arylhydrazine derivatives of formula I of the insecticide composition of the pre-sent invention may be either used in form of a single N-arylhydrazine derivative of formula I or in form of mixtures of different N-arylhydrazine derivatives of formula I or in form of mixtures of at least one N-arylhydrazine derivative of formula I with one or more further pesticides.

The following list of pesticides together with which the N-arylhydrazine derivatives of formula I can be used, is intended to illustrate the possible combinations, but not to impose any limitation:

A.1. Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
A.2. Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
A.3. Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
A.4. Growth regulators: a) chitin synthesis inhibitors: benzoylureas: chlorfluazuron, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
A.5. Nicotinic receptor agonists/antagonists compounds: clothianidin, dinotefuran, imidacloprid, thiamethoxam, nitenpyram, acetamiprid, thiacloprid; the thiazol compound of formula Γ¹

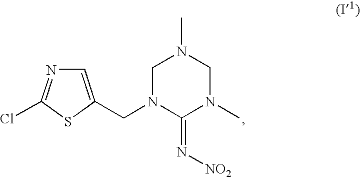

A.6. GABA antagonist compounds: acetoprole, endosulfan, ethiprole, fipronil, vaniliprole, pyrafluprole, pyriprole, the phenylpyrazole compound of formula Γ²

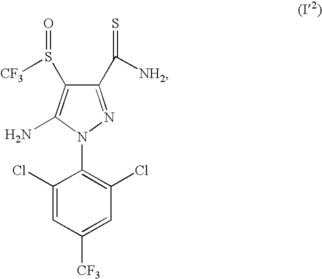

A.7. Macrocyclic lactone insecticides: abamectin, emamectin, milbemectin, lepimectin, spinosad,
A.8. METI I compounds: fenazaquin, pyridaben, tebufenpyrad, tolfenpyrad, flufenerim;
A.9. METI II and III compounds: acequinocyl, fluacyprim, hydramethylnon;
A.10. Uncoupler compounds: chlorfenapyr;
A.11. Oxidative phosphorylation inhibitor compounds: cyhexatin, diafenthiuron, fenbutatin oxide, propargite;
A.12. Moulting disruptor compounds: cyromazine;
A.13. Mixed Function Oxidase inhibitor compounds: piperonyl butoxide;
A.14. Sodium channel blocker compounds: indoxacarb, metaflumizone,
A.15. Various: benclothiaz, bifenazate, cartap, flonicamid, pyridalyl, pymetrozine, sulfur, thiocyclam, flubendiamide, cyenopyrafen, flupyrazofos, cyflumetofen, amidoflumet, the aminoisothiazole compounds of formula Γ³,

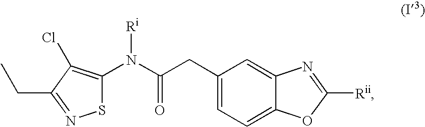

wherein Rⁱ is —CH₂OCH₂CH₃ or H and Rⁱⁱ is CF₂CF₂CF₃ or CH₂CH(CH₃)₃, the anthranilamide compounds of formula Γ⁴

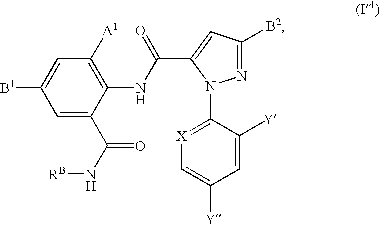

wherein A¹ is CH₃, Cl, Br, I, X is C—H, C—Cl, C—F or N, Y′ is F, Cl, or Br, Y″ is hydrogen, F, Cl, CF₃, B¹ is hydrogen, Cl, Br, I, CN, B² is Cl, Br, CF₃, OCH₂CF₃, OCF₂H, and R^{B} is hydrogen, CH₃ or CH(CH₃)₂, and the malononitrile compounds as described in JP 2002 284608, WO 02/89579, WO 02/90320, WO 02/90321, WO 04/06677, WO 04/20399, JP 2004 99597, WO 05/68423, WO 05/68432, or WO 05/63694, especially the malononitrile compounds CF₂HCF₂CF₂CF₂CH₂C(CN)₂CH₂CH₂CF₃ (2-(2,2,3,3,4,4,5,5-octafluoropentyl)-2-(3,3,3-trifluoropropyl)malononitrile), CF₃(CH₂)₂C(CN)₂CH₂(CF₂)₅CF₂H (2-(2,2,3,3,4,4,5,5,6,6,7,7-Dodecafluoro-heptyl)-2-(3,3,3-trifluoro-propyl)-malononitrile), CF₃(CH₂)₂C(CN)₂(CH₂)₂C(CF₃)₂F (2-(3,4,4,4-Tetrafluoro-3-trifluoromethyl-butyl)-2-(3,3,3-trifluoro-propyl)-malononitrile), CF₃(CH₂)₂C(CN)₂(CH₂)₂(CF₂)₃CF₃ (2-(3,3,4,4,5,5,6,6,6-Nonafluoro-hexyl)-2-(3,3,3-trifluoro-propyl)-malononitrile), CF₂H(CF₂)₃CH₂C(CN)₂CH₂(CF₂)₃CF₂H (2,2-Bis-(2,2,3,3,4,4,5,5-octafluoro-pentyl)-malononitrile), CF₃(CH₂)₂C(CN)₂CH₂(CF₂)₃CF₃ (2-(2,2,3,3,4,4,5,5,5-Nonafluoro-pentyl)-2-(3,3,3-trifluoro-propyl)-malononitrile), CF₃(CF₂)₂CH₂C(CN)₂CH₂(CF₂)₃CF₂H (2-(2,2,3,3,4,4,4-Heptafluoro-butyl)-2-(2,2,3,3,4,4,5,5-octafluoro-pentyl)-malononitrile) and CF₃CF₂CH₂C(CN)₂CH₂(CF₂)₃CF₂H (2-(2,2,3,3,4,4,5,5-Octafluoro-pentyl)-2-(2,2,3,3,3-pentafluoro-propyl)-malononitrile).

The commercially available compounds of the group A may be found in The Pesticide Manual, 13^{th} Edition, British Crop Protection Council (2003) among other publications. Thiamides of formula Γ² and their preparation have been described in WO 98/28279. Aminoisothiazole compounds of formula Γ³ and their preparation have been described in WO 00/06566. Lepimectin is known from Agro Project, PJB Publications Ltd, November 2004. Benclothiaz and its preparation have been described in EP-A1 454621. Methidathion and Paraoxon and their preparation have been described in Farm Chemicals Handbook, Volume 88, Meister Publishing Company, 2001. Acetoprole and its preparation have been described in WO 98/28277. Metaflumizone and its preparation have been described in EP-A1 462 456. Flupyrazofos has been described in Pesticide Science 54, 1988, p. 237-243 and in U.S. Pat. No. 4,822,779. Pyrafluprole and its preparation have been described in JP 2002193709 and in WO 01/00614. Pyriprole and its preparation have been described in WO 98/45274 and in U.S. Pat. No. 6,335,357. Amidoflumet and its preparation have been described in U.S. Pat. No. 6,221,890 and in JP 21010907. Flufenerim and its preparation have been described in WO 03/007717 and in WO 03/007718. Cyflumetofen and its preparation have been described in WO 04/080180. Anthranilamides of formula Γ⁴ and their preparation have been described in WO 01/70671; WO 02/48137; WO 03/24222, WO 03/15518, WO 04/67528; WO 04/33468; and WO 05/118552. The malononitrile compounds CF₂HCF₂CF₂CF₂CH₂C(CN)₂CH₂CH₂CF₃ (2-(2,2,3,3,4,4,5,5-octafluoropentyl)-2-(3,3,3-trifluoropropyl)malononitrile), CF₃(CH₂)₂C(CN)₂CH₂(CF₂)₅CF₂H (2-(2,2,3,3,4,4,5,5,6,6,7,7-Dodecafluoro-heptyl)-2-(3,3,3-trifluoro-propyl)-malononitrile), CF₃(CH₂)₂C(CN)₂(CH₂)₂C(CF₃)₂F (2-(3,4,4,4-Tetrafluoro-3-trifluoromethyl-butyl)-2-(3,3,3-trifluoro-propyl)-malononitrile), CF₃(CH₂)₂C(CN)₂(CH₂)₂(CF₂)₃CF₃ (2-(3,3,4,4,5,5,6,6,6-Nonafluoro-hexyl)-2-(3,3,3-trifluoro-propyl)-malononitrile), CF₂H(CF₂)₃CH₂C(CN)₂CH₂(CF₂)₃CF₂H (2,2-Bis-(2,2,3,3,4,4,5,5-octafluoro-pentyl)-malononitrile), CF₃(CH₂)₂C(CN)₂CH₂(CF₂)₃CF₃ (2-(2,2,3,3,4,4,5,5,5-Nonafluoro-pentyl)-2-(3,3,3-trifluoro-propyl)-malononitrile), CF₃(CF₂)₂CH₂C(CN)₂CH₂(CF₂)₃CF₂H (2-(2,2,3,3,4,4,4-Heptafluoro-butyl)-2-(2,2,3,3,4,4,5,5-octafluoro-pentyl)-malononitrile) and CF₃CF₂CH₂C(CN)₂CH₂(CF₂)₃CF₂H (2-(2,2,3,3,4,4,5,5-Octafluoro-pentyl)-2-(2,2,3,3,3-pentafluoro-propyl)-malononitrile) have been described in WO 05/63694.

Preferred mixtures of N-arylhydrazine derivatives and at least one pesticide are mixtures with similar diffusion/migration properties.

Especially preferred are mixtures of N-arylhydrazine derivatives and at least one pyrethroids.

If the at least one N-arylhydrazine derivative or the at least one pesticide mentioned above have one or more chiral centers in their molecules, they may be applied as racemates, pure enantiomers or diastereomers or in chirally or diastereomerically enriched mixtures.

The at least one N-arylhydrazine derivative of formula I mentioned in the present invention also may be included in the insecticide composition as one of a water-based concentrate or a solvent, preferably an organic solvent, based concentrate or a concentrate based on a mixture of water and a solvent, preferably an organic solvent. Water-based concentrates may be in the form of suspensions or dispersions comprising suitable dispersing agents if necessary or in the form of emulsions comprising emulsifiers, solvents and co-solvents if appropriate. The concentration of the N-arylhydrazine derivative in the water based or solvent based concentrates is in general between 0.5 to 60%, preferably 1 to 40%, more preferably 3 to 20%. Preferred concentrates are water-based concentrates.

### Polymeric Binder (Component B)

The polymeric binder (component B) may be any polymeric binder known in the art. Especially preferred are polymeric binders used in the area of impregnating or coating textile materials or plastics materials.

Preferred binders are for example binders obtainable by polymerization, preferably radical polymerization, of at least one ethylenically unsaturated monomer selected from the group consisting of acrylates, preferably C₁-C₁₂-esters of acrylic acid or acrylates having crosslinked ester functionalities, methacrylates, preferably C₁-C₁₂-esters of methacrylic acid or methacrylates having crosslinked ester functionalities, acrylic acid, methacrylic acid, acrylonitrile, maleic acid, maleic acid anhydride, mono or diesters of maleic acid, styrene, derivatives of styrene such as methyl styrene, butadiene, vinyl acetate, vinyl alcohol, ethylene, propylene, allylic alcohol, vinyl pyrrolidone, vinyl chloride and vinyl dichloride.

The polymerization, preferably radical polymerization, may be carried out for example as bulk polymerization, gas phase polymerization, solvent polymerization, emulsion polymerization or suspension polymerization.

The conditions and further necessary and suitable components for the preparation of suitable polymers by polymerization, preferably radical polymerization, of the monomers mentioned above are known by a person skilled in the art.

Suitable polymeric binders obtained by polymerization, preferably radical polymerization, of the above-mentioned monomers are homopolymers or copolymers, preferably selected from the group consisting of polyacrylates, polymethacrylates, polyacrylonitrile, polymaleic acid anhydride, polystyrene, poly(methyl)styrene, polybutadiene, polyvinylacetate, polyvinylalcohol as well as copolymers obtained by polymerization of at least two different ethylenically unsaturated monomers of the group of monomers mentioned above and blends of said homopolymers and/or copolymers, for example poly(styrene-acrylates), poly(styrene-butadiene), ethylene-acrylate-copolymers, ethylene-vinylacetate-copolymers, which may be partially or completely hydrolyzed.

Further suitable polymeric binders are selected from polyurethanes and/or polyisocyanurates, blends comprising polyurethanes and/or polyisocyanurates, preferably blends comprising polyurethanes and/or polyisocyanurates and polycarbonates;

mineral waxes, zirconium waxes, silicones, polysiloxanes; fluorocarbon resins;
melamine formaldehyde condensation resins, methylol urea derivatives; and curable polyesters;
or
blends or preparations comprising at least one of said polymeric binders.

The polymeric binders mentioned above are known in the art and are either commercially available or can be prepared by preparation processes known in the art.

Further suitable polymeric binders are polyvinylacetates in a formulation comprising a thickener like carboxymethyl cellulose and optionally a cross linking agent like a melamine resin; curable polyesters; formulations comprising reactive silicones (organic polysiloxanes), polyvinyl alcohol, polyvinyl acetate or an acrylic copolymer.

The crosslinking may be carried out thermally or by UV-light or by the dual cure technique. Optionally, a catalyst or a crosslinking agent may be used together with the polymeric binder.

Preferred polymeric binders are selected from the group consisting of acrylic binders and polyurethane and/or polyisocyanurate binders.

Most preferred polymeric binders are acrylic binders. Especially preferred acrylic binders are mentioned below (component B1).

### Acrylic Binders (Component B1)

Most preferred are acrylic binders, which may be homopolymers or copolymers, wherein the copolymers are preferred.

The acrylic binders are preferably obtained by radical polymerization, more preferably radical emulsion polymerization, of at least one monomer of formula II as component B1A

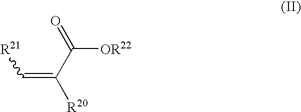

wherein
R²⁰, R²¹ and R²² are independently selected from C₁- to C₁₀-alkyl which may be linear or branched, for example methyl, ethyl, n-propyl, i-propyl, n-butyl, i-butyl, sec-butyl, t-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl, preferably C₁- to C₄-alkyl, for example methyl, ethyl, n-propyl, i-propyl, n-butyl, i-butyl, sec-butyl, tert-butyl; substituted or unsubstituted aryl, preferably substituted or unsubstituted C₆- to C₁₀-aryl, more preferably substituted or unsubstituted C₆-aryl, for example phenyl or tolyl;
R²⁰ and R²¹ may further be H.

Preferably R²⁰ is H or methyl. R²¹ is preferably H; R²² is preferably methyl, ethyl, n-butyl or 2-ethylhexyl.

More preferably R²⁰ is H or methyl, R²¹ is H and R²² is methyl, ethyl, n-butyl or 2-ethylhexyl.

Most preferably the monomer of formula II (component BA) is selected from the group consisting of 2-ethylhexylacrylate, n-butylacrylate, methylacrylate, methylmethacrylate and ethylacrylate. Most preferably a copolymer obtainable by polymerization of at least two different acrylic monomers of formula II is employed.

Most preferably an acrylic binder is used as component B obtainable by emulsion polymerization of
b1a) at least one monomer of formula II as component B1A

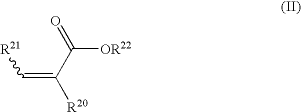

wherein
R²⁰, R²¹ and R²² are independently selected from C₁- to C₁₀-alkyl which may be linear or branched, for example methyl, ethyl, n-propyl, i-propyl, n-butyl, i-butyl, sec-butyl, t-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl, preferably C₁- to C₄-alkyl, for example methyl, ethyl, n-propyl, i-propyl, n-butyl, i-butyl, sec-butyl, tert-butyl; substituted or unsubstituted aryl, preferably substituted or unsubstituted C₆- to C₁₀-aryl, more preferably substituted or unsubstituted C₆-aryl, for example phenyl or tolyl;
R²⁰ and R²¹ may further be H.
Preferably R²⁰ is H or methyl. R²¹ is preferably H; R²² is preferably methyl, ethyl, n-butyl or 2-ethylhexyl.
More preferably R²⁰ is H or methyl, R²¹ is H and R²² is methyl, ethyl, n-butyl or 2-ethylhexyl.
b1b) at least one monomer of formula II as component B1B

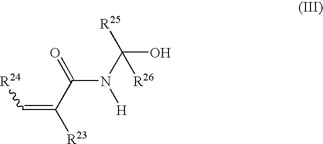

wherein
R²³, R²⁴, R²⁵ and R²⁶ are independently selected from the group consisting of H, C₁- to C₁₀-alkyl which may be linear or branched, for example, methyl, ethyl, n-propyl, i-propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl and n-decyl; preferably R²³, R²⁴, R²⁵ and R²⁶ are selected from the group consisting of H, C₁- to C₄-alkyl, which may be linear or branched, for example methyl, ethyl, n-propyl, iso-propyl, n-butyl, i-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
more preferably R²³ is H or methyl, R²⁴, R²⁵ and R²⁶ are preferably independent of each other H;
most preferably R²³ is H or methyl and R²⁴, R²⁵ and R²⁶ are H;
b1c) optionally at least one monomer of formula IV as component B1C

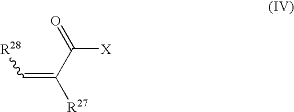

wherein
R²⁷ and R²⁸ are independently selected from the group consisting of H, C₁- to C₁₀-alkyl which may be linear or branched, for example, methyl, ethyl, n-propyl, i-propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl and n-decyl; preferably R²⁷ and R²⁸ are selected from the group consisting of H, C₁- to C₄-alkyl, which may be linear or branched, for example methyl, ethyl, n-propyl, iso-propyl, n-butyl, i-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
most preferably R²⁷ and R²⁸ are H;
X is selected from the group consisting of H, OH, NH₂, OR²⁹OH, glycidyl, hydroxypropyl,

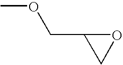

groups of the formula

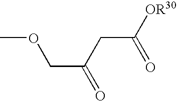

wherein
R³⁰ is selected from the group consisting of C₁- to C₁₀-alkyl which may be branched or linear, for example methyl, ethyl, n-propyl, i-propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl; preferably C₁- to C₄-alkyl, which may be branched or linear, for example methyl, ethyl, n-propyl, iso-propyl, n-butyl, iso-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
R²⁹ is selected from the group consisting of C₁- to C₁₀-alkylene, for example methylene, ethylene, propylene, butylene, pentylene, hexylene, heptylene, octylene, nonylene, decylene; preferably C₁- to C₄-alkylene, for example methylene, ethylene, propylene, butylenes; substituted or unsubstituted arylenes, preferably substituted or unsubstituted C₆- to C₁₀-arylene, more preferably substituted or unsubstituted C₆-arylene, for example phenylene; most preferably X is acetoacetyl;
b1d) further monomers which are copolymerizable with the monomers mentioned above selected from
   b1d1) polar monomers, preferably (meth)acrylic nitrile and/or methyl(meth)acrylate as component B1D1;
      and/or
   b1d2) non polar monomers, preferably styrene and/or a-methylstyrene as component B1D2.

The acrylic binder is preferably obtainable by emulsion polymerization of
b1a) 10 to 95% by weight, preferably 30 to 95% by weight, more preferably 50 to 90% by weight of component B1A;
b1b) 1 to 5% by weight of component B1B;
b1c) 0 to 5% by weight, preferably 1 to 4% by weight, more preferably 0.2 to 3% by weight of component B1C;
b1d) further monomers which are copolymerizable with the monomers mentioned above selected from
   b1d1) 0 to 30% by weight, preferably 0 to 25% by weight, more preferably 5 to 20% by weight of component B1D1; and/or
   b1d2) 0 to 40% by weight, preferably 0 to 30% by weight, more preferably 5 to 20% by weight of component B1D2;
      wherein the sum of the components B1A, B1B and optionally B1C and B1D is 100% by weight.

In a further preferred embodiment the acrylic binder is obtainable by emulsion polymerization of
b1a) 10 to 95% by weight, preferably 30 to 95% by weight, more preferably 50 to 90 by weight of at least one acrylic binder (component B1A) as defined above, comprising;
   b1a1) 10 to 90% by weight, preferably 15 to 85% by weight, more preferably 30 to 85% by weight based on the acrylic binder of n-butyl acrylate;
   b1a2) 10 to 90% by weight, preferably 12 to 85% by weight, more preferably 15 to 65% by weight based on the acrylic binder of at least one monomer of formula II, different from n-butyl acrylate;
b1b) 1 to 5% by weight based on the acrylic binder of at least one monomer of formula III (component B1B);
b1c) 0 to 5% by weight, preferably 0.1 to 4% by weight, more preferably 0.2 to 3% by weight based on the acrylic binder of at least one monomer of formula III (component B1C);
b1d) further monomers which are copolymerizable with the monomers mentioned (component BID) above selected from
   b1d1) 0 to 30% by weight, preferably 0 to 25% by weight, more preferably 5 to 20% by weight based on the acrylic binder of at least one polar monomer, preferably (meth)acrylic nitrile and/or methyl(meth)acrylate (component B1D1); and/or
   b1d2) 0 to 40% by weight, preferably 0 to 30% by weight, more preferably to 20% by weight based on the acrylic binder of at least one non polar monomer, preferably styrene and/or a-methylstyrene (component B1D2);
      wherein the sum of the components B1A, B1B and optionally B1C and B1D is 100% by weight.

The acrylic binder may comprise further additives as known by a person skilled in the art, for example film forming agents and plasticizers, e.g. adipate, phthalate, butyl diglycol, mixtures of diesters preparable by reaction of dicarboxylic acids and alcohols which may be linear or branched. Suitable dicarboxylic acids and alcohols are known by a person skilled in the art.

The insecticide compositions comprising the binder as claimed in the present invention are wash resistant while permitting continuous release of the insecticide at a controlled rate, in order to provide the required bioavailability of the insecticide. It is not necessary to add for example a dispersing agent that, after application of the composition to a fabric and upon wetting of the fabric, reduces the hydrophobicity imparted to the insecticide by the binder to permit limited insecticide release. Preferably, the insecticide composition of the present invention does therefore not comprise a dispersing agent in addition to the polymeric binder.

Most preferably the acrylic binder is obtainable by emulsion polymerization of the following components:
b1a) 50 to 90% by weight of at least one monomer of formula II as component B1A

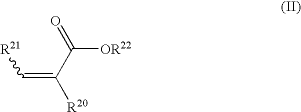

wherein
R²⁰ is H or methyl, R²¹ is H and R²² is methyl, ethyl, n-butyl, or 2-ethylhexyl, as component B1A, most preferably component B1A is 2-ethylhexylacrylate, n-butylacrylate, methylacrylate, methylmethacrylate or ethylacrylate;
b1b) 1 to 5% by weight of at least one monomer of formula III

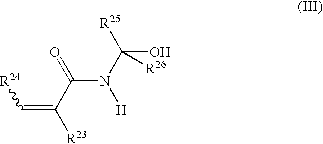

wherein R²³ is H or methyl, R²⁴, R²⁵ and R²⁶ each are H as component B1B;
b1c) 1 to 10% by weight, preferably 1 to 7% by weight, more preferably 2 to 5% by weight of at least one monomer of formula IV

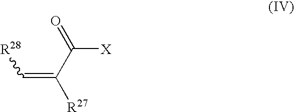

wherein R²⁷ and R²⁸ are H and X is H, OH, NH₂, OR²⁹OH, glycidyl or a group of the formula

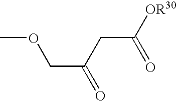

wherein
R³⁰ is selected from the group consisting of C₁- to C₁₀-alkyl which may be branched or linear, for example methyl, ethyl, n-propyl, i-propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl; preferably C₁- to C₄-alkyl, which may be branched or linear, for example methyl, ethyl, n-propyl, iso-propyl, n-butyl, iso-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
R²⁹ is selected from the group consisting of C₁- to C₁₀-alkylene, for example methylene, ethylene, propylene, butylene, pentylene, hexylene, heptylene, octylene, nonylene, decylene; preferably C₁- to C₄-alkylene, for example methylene, ethylene, propylene, butylenes; substituted or unsubstituted arylenes, preferably substituted or unsubstituted C₆- to C₁₀-arylene, more preferably substituted or unsubstituted C₆-arylene, for example phenylene;
as component B1C, most preferably X is acetoacetyl;
b1d) further monomers which are copolymerizable with the monomers mentioned above selected from
   b1d1) 0 to 30% by weight, preferably 0 to 25% by weight, more preferably 5 to 20% by weight of component B1D1, preferably (meth)acrylic nitrile and/or methyl(meth)acrylate;
   and/or
   b1d2) 0 to 40% by weight, preferably 0 to 30% by weight, more preferably 5 to 20% by weight of component BD2, preferably styrene and/or a-methylstyrene;
      wherein the sum of components BA, BB and optionally BC and BD is 100% by weight.

In a further most preferred embodiment the amount of n-butylacrylate as component BA is from 30 to 90% by weight, and the other components B1B and optionally a further monomer of formula II (component B1A), B1C and B1D are chosen as mentioned before, wherein the sum of components B1A, B1B and optionally B1C and B1D is 100% by weight.

The acrylic binder of the present invention is preferably obtainable by emulsion polymerization of the monomers mentioned before. Suitable process conditions are known by a person skilled in the art.

The monomers are polymerized under usual conditions of temperature and pressure, i.e. at from atmospheric pressure to 10 bar and in general at temperatures of from 20 to 100° C., preferably 50 to 85° C., depending on the initiator used. Usually the polymerization is carried out in a stirred reaction vessel under an inert atmosphere.

The copolymerization is generally carried out in water. However, it is also possible to add before, within or after the polymerization process up to 80% by weight, relating to the aqueous phase, of a lower alcohol like methanol, ethanol or isopropanol or a lower ketone like acetone. Preferably the copolymerization is carried out in water without addition of further solvents.

The polymerization process may be carried out continuously or batch-wise, and it is possible to employ the usual methods of batch-wise polymerization, e.g. mixing all polymerization components at once or feeding emulsified monomers and catalysts from one or more metering vessels to a batch containing a portion of a monomer. It is possible to add polymer seed to the polymerization mixture to adjust the particle size of the emulsion polymers obtained.

The emulsion polymerization is preferably carried out in the presence at least one initiator which form radicals under the polymerization conditions. Suitable initiators are for example all common peroxy compounds or azo compounds.

Suitable peroxides are for example alkali metal peroxodisulfates, for example sodium peroxodisulfate, ammonium peroxodisulfate; hydrogen peroxide; organic peroxides, for example diacetyl peroxide, di-tert-butyl peroxide, diamylperoxide, dioctanoyl peroxide, didecanoyl peroxide, dilauroyl peroxide, dibenzol peroxide, bis-(o-toloyl)peroxide, succinyl peroxide, tert-butyl peracetate, tert-butyl permaleinate, tert-butyl perpivalate, tert-butylperoctoate, tert-butyl perneodecanoate, tert-butyl perbenzoate, tert-butyl peroxide, tert-butyl hydroperoxide, cumene hydroperoxide, tert-butyl-peroxy-2-ethylhexanoate, and diisopropyl peroxodicarbamate. Further suitable initiators are azo compounds, for example azobis isobutyronitrile, anzobis(2-amidopropane)dihydrochloride, and 2,2′-azobis(2-methylbutyronitrile).

The initiators are added in usual amounts, for example in an amount of 0.05 to 5% by weight, preferably 0.05 to 2% by weight, based on the total weight of monomers.

If the polymerization is carried out at low temperature, use may be made of conventional redox catalysts. For example, it is possible to use, in addition to the peroxide catalysts of the above kinds, from 0.05 to 2% by weight, based on the total of monomers, of reducing agents such as hydrazine, soluble oxidizable sulfoxy compounds such as alkali metal salts of hydrosulfites, sulfoxylates, thiosulfates, sulfites, and bisulfites, which may be optionally activated by the addition of traces of heavy metals, e.g. salts of Ce, Mo, Fe, and Cu, in the usual manner. Preferred redox catalysts are redox catalysts of acetone disulfite and organic peroxides like tert-C₄Hg—OOH; Na₂S₂O₅ and organic peroxides like tert-C₄—Hg—OOH; or HO—CH₂SO₂H and organic peroxides like tert-C₄Hg—OOH. Further preferred are redox catalysts like ascorbic acid and hydrogen peroxide.

The initiator may be added completely at the beginning of the polymerization, but it is also possible to add the initiator in the course of the emulsion polymerization process in a continuous or stepwise way. The way of adding the initiator is known in the art.

The polymerization process is carried out until a conversion of at least 95% by weight of the monomers is reached. For removal of the residual monomer at the end of the emulsion polymerization initiator may be added for chemical deodoration.

The emulsion polymerization is carried out by adding emulsifiers or mixtures of emulsifiers known in the art. The emulsifiers generally used are ionic (anionic or cationic) and/or non-ionic emulsifiers such as polyglycolethers, sulfonated paraffin hydrocarbons, higher alkylsulfates such as oleyl amine, laurylsulfate, alkali metal salts of fatty acids such as sodium stearate and sodium oleate, sulphuric acid esters of fatty alcohols, ethoxylated C₈₋₁₂-alkylphenols, usually having from 5 to 30 ethylene oxide radicals, and their sulfonation products, and also sulfosuccinic acid esters. The emulsifier or mixtures of emulsifiers are usually employed in an amount of 0.05 to 7% by weight, preferably 0.5 to 4% by weight, based on the total weight of monomers.

In some cases there is added a co-solvent or a mixture of co-solvents to the emulsifiers. Preferred co-solvents are aliphatic C₁- to C₃₀-alcohols which are linear or branched, alicyclic C₃- to C₃₀-alcohols and mixtures thereof. Examples are n-butanol, n-hexanol, cyclohexanol, 2-ethylhexanol, i-octanole, n-octanole, n-decanole, n-dodecanole, stearyl alcohol, oleyl alcohol or cholesterol. Further possible co-solvents are alkane diol, ethylene glycol alkyl ethers, N-alkyl pyrrolidones, and N-alkyl and N,N-dialkyle acid amides like ethylene glycol monobutyl ether, diethylene glycol monoethyl ether, tetraethylene glycol dimethyl ether, N-methylpyrrolidone, N-hexyl pyrolidone, diethyl acid amide or N-octyl acid amide. The co-solvents or mixture of co-solvents is added in an amount of 0 to 20% by weight, preferably 1 to 5% by weight.

In many cases use is also made of a protective colloid, examples of which are polyvinyl alcohol, partially saponified polyvinyl acetates, cellulose derivatives, copolymers of methyl acrylate with acrylic amide and methylacrylic amide or vinyl pyrrolidine polymers in amounts of from 0.5 to 10% by weight and in particular 1.0 to 5% by weight of the weight of the monomers.

Further, it is possible to add in general up to 10% by weight, preferably 0.05 to 5% by weight of mono- or di-olefinically unsaturated monomers containing reactive or cross-linking groups. Examples of such monomers are in particular the amides of α,β-olefinically unsaturated C₃₋₅-carboxylic acids, particularly acryl amides, methacryl amides and maleic diamides, and their N-methylol derivatives such as N-methylol acrylic amide, N-methylol methacrylic amide, N-alkoxy methyl amides of α,β-monoolefinically unsaturated C₃₋₅-carboxylic acids such as N-methoxy methacrylic amide and N-n-butoxymethylacrylic amide, vinyl sulfonic acid, monoesters of acrylic and methacrylic acids with alkanediols such as glycol, butanediol-1,4, hexane diol-1,6, and 3-chloropropanediol-1,2, and also allyl and methallyl esters of α,β-olefinically unsaturated mono- and di-carboxylic acids such as diallyl maleate, dimethyl allyl fumarate, allyl acrylate and allyl methacrylate, diallyl phthalate, diallyl terephthalate, p-di-vinyl benzene, methylene-bis-acrylamide and ethylene glycol di-allylether.

The solids content of the aqueous dispersions of polymers obtained in the emulsion polymerization is usual 15 to 75% by weight, preferably 25 to 50% by weight. To obtain high space time yields of the reactor dispersions having a high solids content are preferred. To obtain solids contents of more than 60% by weight a bi- or polymodal particle distribution should be adjusted, because otherwise it is not possible to handle the dispersion, because of the high viscosity. New particle generations (for obtaining bi- or polymodel particle size distributions) are for example formed by addition of seed (EP-A 0 810 831), addition of an excess of emulsifier or addition of mini-emulsions. The formation of new particle generations may be carried out at any time and is depending on the desired particle size distribution for a low viscosity.

The molecular weight of the non crosslinked emulsion polymers obtained is in general 40,000 to 250,000 (determined by GPC). The molecular weight is usually controlled by the use of conventional chain stoppers in conventional amounts. Conventional chain stoppers are for example sulfoorganic compounds.

The acrylic binder of the present invention is obtained in form of its aqueous dispersion and is preferably employed in the insecticide compositions of the present invention in form of the aqueous dispersion.

Polyurethane Binders and/or Polyisocyanurate Binders (Component B2)

In a further preferred embodiment the polymeric binders are polyurethanes and/or polyisocyanurates. Said polyurethanes and/or polyisocyanurates may be employed either alone as polymeric binders or in combination with further polymeric binders, especially polymeric binders mentioned before, for example in combination with the acrylic binders mentioned before.

Suitable polymeric binders are therefore:

at least one polyurethane as component B2, obtainable by reaction of the following components:
b2a) at least one diisocyanate or polyisocyanate as component B2A, preferably aliphatic, cycloaliphatic, araliphatic and/or aromatic insocyanates, more preferably diisocyanates, which are optionally biuretisized and/or isocyanurized, most preferably 1-isocyanato-3,3,5-trimethyl-5-isocyanatomethylene cyclohexane (IPDI) and hexamethylene diisocyanate-1,6 (HMDI);
b2b) at least one diol, triol or polyol as component B2B, preferably aliphatic, cycloaliphatic and/or araliphatic diols having 2 to 14, preferably 4 to 10 carbon atoms, more preferably 1,6-hexanediol or neopentyl glycol;
b2c) optionally further components as component B2C, preferably adipic acid or carbonyl diimidazole (CDI); and
   b2d) optionally further additives as component B2D.

The polyurethane is preferably obtainable by reaction of the following components:
b2a) 55 to 99% by weight, preferably 70 to 98% by weight, more preferably 75 to 90 by weight based on the polyurethane of at least one diisocyanate or polyisocyanate (component B2a), preferably aliphatic, cycloaliphatic, araliphatic and/or aromatic insocyanates, more preferably diisocyanates, which are optionally biuretisized and/or isocyanurized, more preferably alkylene diisocyanates having from 4 to 12 carbon atoms in the alkylene unit, like 1,12-dodecane diisocyanate, 2-ethyltetramethylene diisocyanate-1,4,2-methylpentamethylene diisocyanate-1,5, tetramethylene diisocyanate-1,4, lysinester diisocyanate (LDI), hexamethylene diisocyanate-1,6 (HMDI), cyclohexane-1,3- and/or -1,4-diisocyanate, 2,4- and 2,6-hexahydro-toluoylene diisocyanate as well as the corresponding isomeric mixtures 4,4′-, 2,2′- and 2,4′-dicyclohexylmethane diisocyanate as well as the corresponding mixtures, 1-isocyanato-3,3,5-trimethyl-5-isocyanatomethyl cyclohexane (IPDI), 2,4- and/or 2,6-toluoylene diisocyanate, 4,4′-, 2,4′ and/or 2,2′-diphenylmethane diisocyanate (monomeric MDI), polyphenylpolymethylene polyisocyanate (polymeric MDI) and/or mixtures comprising at least 2 of the isocyanates mentioned before; further ester-, urea-, allophanate-, carbodiimid-, uretdione- and/or urethane groups comprising di- and/or polyisocyanates may be used; most preferably 1-isocyanato-3,3,5-trimethyl-5-isocyanatomethylene cyclohexane (IPDI) and hexamethylene diisocyanate-1,6 (HMDI);
b2b) 10 to 90% by weight, preferably 12 to 85% by weight, more preferably 15 to 65% by weight based on the polyurethane of at least one diol, triol or polyol (component B2B), preferably aliphatic, cycloaliphatic and/or araliphatic diols having 2 to 14, preferably 4 to 10 carbon atoms, more preferably polyols, selected from the group consisting of polyetherols, e.g. polytetrahydrofurane, polyesterols, polythioetherpolyols, hydroxyl group containing polyacetales and hydroxyl group containing aliphatic polycarbonates or mixtures of at least 2 of the polyols mentioned before. Preferred are polyesterols and/or polyetherols. The hydroxyl number of the polyhydroxy compounds is in general from 20 to 850 mg KOH/g and preferably 25 to 80 mg KOH/g. Further, diols and/or triols having a molecular weight of from in general 60 to <400, preferably from 60 to 300 g/mol are employed. Suitable diols are aliphatic, cycloaliphatic and/or araliphatic diols having from 2 to 14, preferably 4 to 10 carbon atoms, e.g. ethylene glycol, propane diol-1,3, decane diol-1,10, o-, m-, p-dihydroxycyclohexane, diethylene glycol, dipropylene glycol and preferably butane diol-1,4, neopentyl glycol, hexane diol-1,6 and bis-(2-hydroxy-ethyl)hydroquinone, triols, like 1,2,4-, 1,3,5-trihydroxycyclohexane, glycerine and trimethylol propane and mixtures of low molecular hydroxyl groups containing polyalkylene oxides based on ethylene oxide and/or 1,2-propylene oxide and the diols and/or triols mentioned before;
b2c) 0 to 10% by weight, preferably 0.1 to 5% by weight, more preferably 1 to 5% by weight based on the polyurethane of further components (component B2C), preferably adipic acid or carbonyl diimidazole (CDI); and
b2d) 0 to 10% by weight, preferably 0.1 to 5% by weight, more preferably 0.5 to 5% by weight based on the polyurethane of further additives (component B2D);
   wherein the sum of the components B2A, B2B, B2C and B2D is 100% by weight.

The polyurethanes are prepared by methods known in the art. Further, additives as known by a person skilled in the art may be used in the process for preparing the polyurethanes.

Component B may also be a polyisocyanurate or a mixture of a polyisocyanurate and a polyurethane, preferably a polyurethane as mentioned above.

Polyisocyanurates are polymers comprising groups of the following formula:

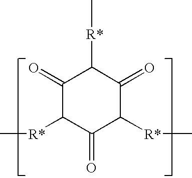

wherein R* is an alkylene or arylene residue depending on the isocyanate employed in the preparation of the isocyanurate.

Polyisocyanurates are usually prepared by cyclotrimerization of isocyanates. Preferred isocyanates are the same isocyanates as mentioned before (component B2A). Preparation processes and conditions for the preparation of polyisocyanurates are known by a person skilled in the art.

According to a preferred embodiment of the present invention there is provided an insecticide composition for application to a non-living material which composition comprises a mixture including
a) at least one N-arylhydrazine derivative of formula I as component A, and
b1) at least one acrylic binder as component B1 obtainable by polymerization, preferably emulsion polymerisation, of the following components:
   b1a) at least one monomer of formula II as component B1A

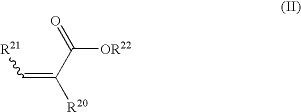

wherein
R²⁰, R²¹ and R²² are independently selected from C₁- to C₁₀-alkyl which may be linear or branched, for example methyl, ethyl, n-propyl, i-propyl, n-butyl, i-butyl, sec-butyl, t-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl, preferably C₁- to C₄-alkyl, for example methyl, ethyl, n-propyl, i-propyl, n-butyl, i-butyl, sec-butyl, tert-butyl; substituted or unsubstituted aryl, preferably substituted or unsubstituted C₆- to C₁₀-aryl, more preferably substituted or unsubstituted C₆-aryl, for example phenyl or tolyl;
R²⁰ and R²¹ may further be H.
Preferably R²⁰ is H or methyl. R²¹ is preferably H; R²² is preferably methyl, ethyl, n-butyl or 2-ethylhexyl.
More preferably R²⁰ is H or methyl, R²¹ is H and R²² is methyl, ethyl, n-butyl or 2-ethylhexyl.
b1b) at least one monomer of formula III as component B1B

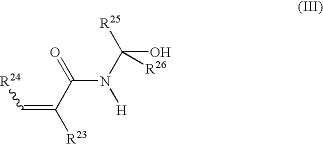

wherein
R²³, R²⁴, R²⁵ and R²⁶ are independently selected from the group consisting of H, C₁- to C₁₀-alkyl which may be linear or branched, for example, methyl, ethyl, n-propyl, i-propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl and n-decyl; preferably R²³, R²⁴, R²⁵ and R²⁶ are selected from the group consisting of H, C₁- to C₄-alkyl, which may be linear or branched, for example methyl, ethyl, n-propyl, iso-propyl, n-butyl, i-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
more preferably R²³ is H or methyl, R²⁴, R²⁵ and R²⁶ are preferably independent of each other H;
most preferably R²³ is H or methyl and R²⁴, R²⁵ and R²⁶ are H;
b1c) optionally at least one monomer of formula IV as component B1C

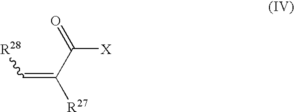

wherein
R²⁷ and R²⁸ are independently selected from the group consisting of H, C₁- to C₁₀-alkyl which may be linear or branched, for example, methyl, ethyl, n-propyl, i-propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl and n-decyl; preferably R²⁷ and R²⁸ are selected from the group consisting of H, C₁- to C₄-alkyl, which may be linear or branched, for example methyl, ethyl, n-propyl, iso-propyl, n-butyl, i-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
most preferably R²⁷ and R²⁸ are H;
X is selected from the group consisting of H, OH, NH₂, OR²⁹OH, glycidyl, hydroxypropyl,

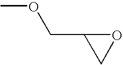

groups of the formula

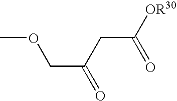

wherein
R³⁰ is selected from the group consisting of C₁- to C₁₀-alkyl which may be branched or linear, for example methyl, ethyl, n-propyl, i-propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl; preferably C₁- to C₄-alkyl, which may be branched or linear, for example methyl, ethyl, n-propyl, iso-propyl, n-butyl, iso-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
R²⁹ is selected from the group consisting of C₁- to C₁₀-alkylene, for example methylene, ethylene, propylene, butylene, pentylene, hexylene, heptylene, octylene, nonylene, decylene; preferably C₁- to C₄-alkylene, for example methylene, ethylene, propylene, butylenes; substituted or unsubstituted arylenes, preferably substituted or unsubstituted C₆- to C₁₀-arylene, more preferably substituted or unsubstituted C₆-arylene, for example phenylene; most preferably X is acetoacetyl;
b1d) further monomers which are copolymerizable with the monomers mentioned above selected from
   b1d1)polar monomers, preferably (meth)acrylic nitrile and/or methyl(meth)acrylate as component B1D1;
   and/or
   b1d2) non polar monomers, preferably styrene and/or a-methylstyrene as component B1D2.
      and/or
b2) at least one polyurethane and/or polyisocyanurate as component B2, wherein the polyurethane is obtainable by reaction of the following components:
   b2a) at least one diisocyanate or polyisocyanate as component B2A, preferably aliphatic, cycloaliphatic, araliphatic and/or aromatic insocyanates, more preferably diisocyanates, which are optionally biuretisized and/or isocyanurized, most preferably 1-isocyanato-3,3,5-trimethyl-5-isocyanatomethylene cyclohexane (IPDI) and hexamethylene diisocyanate-1,6 (HMDI);
   b2b) at least one diol, triol or polyol as component B2B, preferably aliphatic, cycloaliphatic and/or araliphatic diols having 2 to 14, preferably 4 to 10 carbon atoms, more preferably 1,6-hexanediol or neopentyl glycol;
   b2c) optionally further components as component B2C, preferably adipic acid or carbonyl diimidazole (CDI); and
   b2d) optionally further additives as component B2D.

Preferably, the insecticide composition comprises at least one acrylic binder (component B1) as defined before.

In a preferred embodiment the insecticide composition of the present invention comprises:
a) 0.1 to 45% by weight, preferably 0.5 to 30% by weight, more preferably 1 to 25% by weight of at least one N-arylhydrazine derivative of formula I (component A),
   and
b1) 55 to 99% by weight, preferably 70 to 98% by weight, more preferably 75 to 90 by weight of at least one acrylic binder (component B1),
   and/or
b2) 55 to 99% by weight, preferably 70 to 98% by weight, more preferably 75 to 90 by weight of at least one polyurethane and/or polyisocyanurate (component B2),
   wherein the sum of the components is 100% by weight of solids content of the insecticide composition.

Preferably, the insecticide composition comprises at least one acrylic binder (component B1) as defined before.

In a further preferred embodiment the insecticide composition comprises the following components, based on the solids content of the composition
a) 20 to 70% by weight, preferably 25 to 65% by weight, more preferably 30 to 65% by weight of at least one N-arylhydrazine derivative of formula I (component A),
   and
b1) 30 to 80% by weight, preferably 35 to 75% by weight, more preferably 35 to 70 by weight of at least one acrylic binder (component B1);
   and/or
b2) 30 to 80% by weight, preferably 35 to 75% by weight, more preferably 35 to 70 by weight of at least one polyurethane and/or polyisocyanurate (component B2),
   wherein the sum of the components is 100% by weight of solids content of the insecticide composition.

Preferably, the insecticide composition comprises at least one acrylic binder (component B1) as defined before.

Preferred non-living materials, N-arylhydrazine derivatives of formula I and acrylic binders (component B1) and polyurethane and/or polyisocyanurate binders (component B2) as well as preferred amounts of said components in the insecticide compositions of the present invention are mentioned before.

### Insecticide Compositions

The insecticide compositions of the present invention may be aqueous compositions comprising water or dry compositions, e.g. compositions which do not comprise water.

In a preferred embodiment the ready-to-use insecticide compositions are aqueous compositions, preferably comprising 55 to 97% by weight, more preferably 85 to 95% by weight of water, and 3 to 45% by weight, preferably 5 to 15% by weight of solids, based on the total of the components in the insecticide compositions of the present invention, wherein the total is 100% by weight. The solids are preferably selected from the group consisting of at least one N-arylhydrazine of formula I as component A as defined above, and at least one polymeric binder as component B as defined above, and optionally at least one fixative agent as component C as defined below, and optionally further components depending on the use of the final product as defined above.

The treatment baths from which the insecticide compositions are applied to the non-living material are preferably aqueous formulations comprising 95 to 99.5% by weight, preferably 95 to 99% by weight, more preferably 97 to 99% by weight of water, and 0.5 to 5% by weight, preferably 1 to 5% by weight of solids, based on the total of the components in the insecticide compositions of the present invention. The solids are preferably selected from the group consisting of at least one N-arylhydrazine of formula I as component A as defined above, and at least one polymeric binder as component B as defined above, and optionally at least one fixative agent as component C as defined below, and optionally further components depending on the use of the final product as defined above.

Depending on the use of the final product the insecticide composition of the present invention may further comprise one or more components selected from water, preservatives, detergents, fillers, impact modifiers, anti-fogging agents, blowing agents, clarifiers, nucleating agents, coupling agents, conductivity-enhancing agents (anti-stats), stabilizers such as anti-oxidants, carbon and oxygen radical scavengers and peroxide decomposing agents and the like, flame retardants, mould release agents, agents having UV protecting properties, optical brighteners, spreading agents, anti-blocking agents, anti-migrating agents, foam-forming agents, anti-soiling agents, thickeners, further biocides, wetting agents, plasticizers and film forming agents, adhesive or anti-adhesive agents, optical brightening (fluorescent whitening) agents, fragrance, pigments and dyestuffs.

Suitable anti-foam agents are for example silicon anti-foam agents. Suitable UV-protecting agents for protecting UV-sensitive insecticides and/or repellents are for example para-aminobenzoic acids (PABA), octylmethoxysinameth, stilbenes, styryl or benzotriazole derivatives, benzoxazol derivatives, hydroxy-substituted benzophenones, salicylates, substituted triazines, cinnamic acid derivatives (optionally substituted by 2-cyano groups), pyrazoline derivatives, 1,1′-biphenyl-4,4′-bis-2-(methoxyphenyl)-ethenyl or other UV protecting agents. Suitable optical brighteners are dihydroquinolinone derivatives, 1,3-diaryl pyrazoline derivatives, pyrenes, naphthalic acid imides, 4,4′-di-ystyryl biphenylene, 4,4′-diamino-2,2′-stilbene disulphonic acids, cumarin derivatives and benzoxazole, benzisoxazole or benzimidazole systems which are linked by —CH═CH-bridges or other fluorescent whitening agents.

Typical pigments used in the insecticide compositions of the present invention are pigments which are used in pigment dyeing or printing processes or are applied for the coloration of plastics and are known by a person skilled in the art.

Pigments may be inorganic or organic by their chemical nature. Inorganic pigments are mainly used as white pigments (e.g., titanium dioxide in the form of rutile or anatas, ZnO, chalk) or black pigments (e.g., carbon black). Colored inorganic pigments may be used as well but are not preferred because of potential toxicologic hazards. For imparting color, organic pigments or dyestuffs are preferred. Organic pigments may be mono or disazo, naphthol, benzimidazolone, (thio) indigoid, dioxazine, quinacridone, phthalocyanine, isoindolinone, perylene, perinone, metal complex or diketo pyrrolo pyrrole type pigments. Pigments may be used in powder or liquid form (i.e., as a dispersion). Preferred pigments are Pigment Yellow 83, Pigment Yellow 138, Pigment Orange 34, Pigment Red 170, Pigment Red 146, Pigment Violet 19, Pigment Violet 23, Pigment Blue 15/1, Pigment Blue 15/3, Pigment Green 7, Pigment Black 7. Other suitable pigments are known to a person skilled in the art.

Typical dyestuffs which may be used in the present invention are vat dyes, cationic dyes and disperse dyes in powder or liquid form. Vat dyes may be used as pigments or following the vatting (reduction) and oxidation procedure. Using the vat pigment form is preferred. Vat dyes may be of the indanthrone type, e.g. C.I. Vat Blue 4, 6 or 14; or of the flavanthrone type, e.g. C.I. Vat Yellow 1; or of the pyranthrone type, e.g. C.I. Vat Orange 2 and 9; or of the isobenzanthrone (isoviolanthrone) type, e.g. C.I. Vat Violet 1; or of the dibenzanthrone (violanthrone) type, e.g. C.I. Vat Blue 16, 19, 20 and 22, C.I. Vat Green 1, 2 and 9, C.I. Vat Black 9; or of the anthraquinone carbazole type, e.g. C.I. Vat Orange 11 and 15, C.I. Vat Brown 1, 3 and 44, C.I. Vat Green 8 and C.I. Vat Black 27; or of the benzanthrone acridone type, e.g. C.I. Vat Green 3 and 13 and C.I. Vat Black 25; or of the anthraquinone oxazole type, e.g. C.I. Vat Red 10; or of the perylene tetra carbonic acid diimide type, e.g. C.I. Vat Red 23 and 32; or imidazole derivatives, e.g. C.I. Vat Yellow 46; or amino triazine derivatives, e.g. C.I. Vat Blue 66. Other suitable vat dyes are known by a person skilled in the art.

Typical disperse and cationic dyestuffs are known by a person skilled in the art.

If cellulosic substrates are employed as non-living material, said cellulosic substrates are preferably dyed with vat, direct, reactive or sulphur dyestuffs.

In a further embodiment the insecticide compositions of the present invention are insecticide compositions as mentioned before comprising at least one pigment and/or at least one dyestuff. The insecticide compositions of the present invention preferably comprise 10 to 300% by weight, more preferably 20 to 150% by weight of the pigment and/or dyestuff relating to the total weight of the solids content of the insecticide and/or repellent.

The non-living material, for example textile material or plastics material, according to the present invention and by use of a composition as described in the present invention may be impregnated locally when the composition is delivered in the form of a kit comprising the ingredients of the insecticide composition in a handy form. In a further embodiment the present invention therefore relates to an insecticide composition as described in the present invention which is provided as a kit for impregnation by the end-user or in a local factory. In a preferred embodiment the kit is adapted for preparing a solution or emulsion by adding water. The ingredients of the kit may accordingly be in form of a dry composition such as a powder, a capsule, a tablet, or an effervescent tablet. In a further embodiment, the kit comprises an emulsion wherein water is added by the end-user or in a local factory. The emulsion may be a micro-emulsion, which is generally very stable. The emulsion may be embodied in a capsule.

The kit comprises at least the following ingredients:
a) at least one N-arylhydrazine derivative of formula I, and
b) at least one polymeric binder; preferred polymeric binders are described in the present invention.

Preferred N-arylhydrazine derivatives as well as preferred polymeric binders are already mentioned in the present invention. The kit may contain further ingredients as mentioned above, especially one or more compounds selected from preservatives, detergents, stabilizers, agents having UV-protecting properties, optical brighteners, spreading agents, anti-migrating agents, foam-forming agents, wetting agents, anti-soiling agents, thickeners, further biocides, plasticizers, adhesive agents, fragrance, pigments and dyestuffs. Preferred kits comprise beside the N-arylhydrazine derivative and the polymeric binder at least one pigment and/or at least one dyestuff. Preferred pigments and dyestuffs are mentioned before.

In a further embodiment the present invention relates to an impregnated non-living material for combating of an insect comprising
a) at least one N-arylhydrazine derivative of formula I, and
b) at least one polymeric binder; preferred polymeric binders are described in the present invention.

Preferred N-arylhydrazine derivatives of formula I and preferred polymeric binders are mentioned before. Preferred non-living materials are also mentioned before.

A typical amount of N-arylhydrazine derivative of formula I in the impregnated non-living material is from 0.01 to 10% (dry weight) of the (dry) weight of the non-living material dependent on the insecticidal efficiency of the N-arylhydrazine derivative of formula I. A preferred amount is between 0.05 and 7% by weight of the non-living material depending on the N-arylhydrazine derivative of formula I.

A typical amount for the polymeric binder is from 0.001 to 10% by weight (dry weight) of the (dry) weight of the non-living material. As a rule, the higher amount the N-arylhydrazine derivative of the specific type to be added, the higher the concentration of the polymeric binder so that the ratio between N-arylhydrazine derivative and binder is approximately constant with a value depending on the insecticidal and migratory ability of the N-arylhydrazine derivative. Preferred amounts of polymeric binder are from 0.1 to 5% by weight, more preferably 0.2 to 3% by weight of the (dry) weight of the non-living material.

In a further embodiment, the impregnated non-living material according to the present invention further comprises one or more components selected from preservatives, detergents, stabilizers, agents having UV-protecting properties, optical brighteners, spreading agents, anti-migrating agents, foam-forming agents, wetting agents, anti-soiling agents, thickeners, further biocides, plasticizers, adhesive agents, pigments and dyestuffs. Suitable examples of the components mentioned above are known by a person skilled in the art.

In a further embodiment of the present invention the impregnated non-living material comprises besides the at least one N-arylhydrazine derivative of formula I and the at least one polymeric binder as described before at least one pigment and/or at least one dyestuff. The amount of the at least one pigment is in general from 0.05 to 10% by weight, preferably 0.1 to 5% by weight, more preferably 0.2 to 3.5% by weight of the (dry) weight of the non-living material. The amount of the at least one dyestuff is in general from 0.05 to 10% by weight, preferably 0.1 to 5% by weight, more preferably 0.2 to 3.5% by weight of the (dry) weight of the non-living material. The non-living material comprises preferably either at least one pigment or at least one dyestuff. Suitable pigments and dyestuffs are mentioned before.

### Process for Impregnation of a Non-Living Material

In a further embodiment, the present invention relates to a process for impregnation of a non-living material, for example a textile material or plastics material, comprising
i) forming an aqueous formulation or a melt, wherein an aqueous formulation is preferred, comprising at least one N-arylhydrazine derivative of formula I and at least one polymeric binder, preferably a polymeric binder as defined in the present invention, and optionally further ingredients;
ii) applying the aqueous formulation to the non-living material by
   iia) passing the non-living material through the aqueous formulation;
   or
   iib) bringing the non-living material in contact with a roller that is partly or fully dipped into the aqueous formulation and drawing the aqueous formulation to the side of the non-living material in contact with the roller,
   or
   iic) double-side coating of the non-living material
   or
   iid) spraying the aqueous formulation onto the non-living material, wherein the spraying is carried out with any suitable device for spraying by hand or automatically, for example with an aerosol can or devices usually used in a factory;
   or
   iie) applying the aqueous formulation in form of a foam;
   or
   iif) submerging the non-living material into the aqueous formulation;
   or
   iig) brushing the aqueous formulation onto or into the non-living material;
   or
   iih) pouring the aqueous formulation onto the non-living material;
   or
   applying the melt by calendering or with a doctor-blade;
      iii) optionally removing surplus aqueous formulation or surplus melt; and
      iv) drying and/or curing the non-living material

In the context of the present invention an aqueous formulation may be a solution, an emulsion or a suspension/dispersion.

The aqueous formulation or the melt preferably comprises the insecticide composition as disclosed in the present invention, which is preferably employed in form of an aqueous formulation.

In the context of the present invention “impregnation” is a process for applying the insecticide composition. This process may include a process for curing the applied insecticide composition to achieve a coating onto the non-living material, if desired. An “impregnated non-living material” is a material onto which the insecticide composition is applied. The “impregnated non-living material” may be coated by curing the applied insecticide composition, if desired.

The insecticide composition of the present invention may also be applied onto the non-living material by transfer printing, inkjet printing, a screen process, and powder printing.

Suitable non-living materials are mentioned before. It is possible to impregnate the non-living material, for example the textile or plastics material, in form of its finished product (end of line treatment, discontinuous treatment). In this case no further pass is necessary after impregnation. However, it is also possible to impregnate the non-living material, for example the textile or plastics material, in form of a yarn or fibers, which have to be further processed after impregnation to obtain the desired finished product (in line treatment). Preferred N-arylhydrazine derivatives of formula I used are also defined before as well as preferred polymeric binders.

The discontinuous treatment may be performed in factories, in local treatment centers (local factories) or even with mobile equipment which is e.g. mounted on trucks or pickups (e.g. in re-treatment antimalaria campaigns). The discontinuous treatment may be done on new (untreated non-living materials, for example textile materials or plastics materials, preferably nettings, in use or made-up form (preferably as nets)) or on used non-living materials, for example textile materials or plastics materials (preferably nets), preferably after washing.

It is one advantage of the present invention that the impregnation is carried out in an aqueous formulation or in a melt. It is not necessary to add any organic solvents. In a preferred embodiment of the present invention the treatment bath is an aqueous formulation which does not comprise any further solvents, especially no organic solvents.

It is advantageous to avoid the use of organic solvents because the non-living material, for example the textile material or plastics material of the present invention may be used in close contact to the human body. The non-living material, for example textile material or plastics material, impregnated by the method of the present invention does not comprise any organic solvent residue which is beneficial both from a human toxicological and an ecological point of view.

The aqueous formulation or the melt employed in the impregnation process may further comprise one or more ingredients selected from the group consisting of preservatives, detergents, stabilisers, agents having UV-protecting properties, spreading agents, anti-migrating agents, foam-forming agents, wetting agents, anti-soiling agents, thickeners, further biocides, plasticizers, adhesive agents, fragrance, pigments and dyestuffs.

In a further embodiment the aqueous formulations or the melts employed for impregnation of the non-living material comprise in addition to the at least one N-arylhydrazine derivative of formula I and the at least one polymeric binder at least one pigment and/or at least one dyestuff. These aqueous formulations or melts are suitable for impregnation of the non-living material with at least one N-arylhydrazine derivative and additionally coloring the non-living material at the same time. Many of the non-living material which are impregnated with at least one N-arylhydrazine derivative are preferably colored. With the process of the present invention it is possible to color and impregnate the non-living material with an N-arylhydrazine derivative at the same time. The method of the present invention is therefore very economical, because the coloring and impregnation with an N-arylhydrazine derivative is carried out in one step.

In a further embodiment of the present invention the present invention therefore relates to a process for impregnation of a non-living material as described before, wherein the dyeing of the non-living material is carried out simultaneously with the impregnation of the non-living material, wherein an aqueous formulation is formed further comprising at least one dyestuff and/or at least one pigment.

Suitable amounts of pigments are in general 0.01 to 20% by weight, preferably 0.1 to 10% by weight, more preferably 0.2 to 5% by weight, based on the weight of the aqueous formulation used for impregnation. Suitable dyestuffs are employed in general in an amount of from 0.01 to 20% by weight, preferably 0.1 to 10% by weight, more preferably 0.2 to 5% by weight, based on the weight of the aqueous formulation used for impregnation.

Step i) Forming an Aqueous Formulation Comprising at Least One N-Arylhydrazine Derivative Of Formula I and at Least One Polymeric Binder and Optionally Further Ingredients The aqueous formulation is formed by mixing all ingredients necessary for impregnation of the non-living material with water. The aqueous formulation is generally formed at temperatures of from 10 to 70° C., preferably 15 to 50° C., more preferably 20 to 40° C. Suitable aqueous formulations comprise an insecticide composition for application to a non-living material as described in the present invention.
Step ii) Applying the Aqueous Formulation Comprising at Least One N-Arylhydrazine Derivative of Formula I and at Least One Polymeric Binder and Optionally Further Ingredients to the non-living material
Step iia)

The insecticide composition is applied by passing the non-living material through the aqueous formulation. This step is known by a person skilled in the art as padding. In a preferred embodiment the non-living material is completely submerged in the aqueous treatment liquor (aqueous formulation) either in a trough containing the liquor or passed through the treatment bath (aqueous formulation) which is held between two horizontally oriented rollers.

In accordance with the invention, the non-living material may either be passed through the aqueous formulation or the aqueous formulation may be passed through the non-living material. These processes are preferred for impregnating open-width material, especially textile or plastics material, which is later tailored into nets. For small-scale production or re-impregnating of non-treated nets, use of a simple hand-held roller might be sufficient.

Step iib)

It is further possible to apply the aqueous formulation onto the non-living material by one-side only-coating applications methods. Suitable one-side only-coating application methods are for example knife-/doctor-blade-coating, roller coating or screen-printing. By this methods it is possible to impregnate only one side of the non-living material which is advantageous, if e.g. direct contact of the human skin with insecticide-treated material is to be avoided.

Knife-/doctor-blade-coating systems are for example knife-over-air-systems, knife-over-roller systems, knife-over-table systems or knife-over-rubber-belt systems. Further knife coating systems are for example commabar or Mayerbar knife systems.

Roller-coating systems are for example kiss-coating systems with one, two, three or more rollers, reverse-roll-coater systems and raster roll systems. In these roller-coating systems at least one roller is partly dipped into the aqueous formulation thus applying the aqueous formulation to the side of the non-living material in contact with the roller (kiss-rolling).

Screen-printing systems are for example rotary-screen printing systems and flat-screen printing systems. With these applications methods a dot coating or a full-surface coating can be applied to the non-living material, for example by using an additional whisper-blade behind the rotary-screen.

A person skilled in the art will adjust the viscosity of the aqueous formulation used by applying thickeners where appropriate.

Step iic)

It is further possible to apply the aqueous formulations to the non-living material by double-side coating application methods, for example double-side knife-coating systems, foulard with two air-knifes or foulard with squeezing rollers.

By using the double-side-knife-coating system or by passing two times through a one-side-only coating system, it is possible to apply the aqueous formulation only to the surfaces of both sides of the non-living material and thus to reduce the quantity of the aqueous formulations needed for a certain effect.

Step iid) and Step iie)

It is further possible to apply the aqueous formulation by spraying the solution or emulsion onto the non-living material. Further it is possible, to apply the emulsion in the form of a foam which is applied to the non-living material. A foam comprises less water than the solution or emulsion mentioned above. The drying process may therefore be very short.

Step iif, iig) and Step iih)

It is further possible to apply the aqueous formulation onto the non-living material by submerging the non-living material into the aqueous formulation, brushing the aqueous formulation onto or into the non-living material, or pouring the aqueous formulation onto the non-living material. Said methods are known by a person skilled in the art.

Impregnation of the non-living material in step iia), iib), iic), iid), iie), iif, iig), or iih) is carried out at temperatures of in general from 10 to 70° C., preferably 15 to 50° C., more preferably 20 to 40° C.

Step iii) Optionally Removing the Surplus Aqueous Formulation

The surplus aqueous formulation is usually removed by squeezing the non-living material, for example the textile material or plastics material, preferably by passing the non-living material rollers as known in the art, preferably by means of doctor blade, thus achieving a defined liquor uptake. The squeezed-off liquor is usually re-used.

The surplus aqueous formulation may alternatively be removed by centrifuging or vacuum suction.

Step iv) Drying and/or Curing the Non-Living Material

The drying is in general carried out temperatures below 200° C. Preferred temperatures are from 50 to 170° C., more preferably from 70 to 150° C. The temperature choice is a function of the evaporation temperature and mobility of the insecticide in the formulation.

It should be noted that the drying process may be a passive drying as the process may be carried out in rather hot climates. An active drying process would normally be performed during high scale processing.

After or simultaneously to the drying, the impregnated non-living material is optionally finally cured and/or fixated. A person skilled in the art knows how to carry out a curing and/or fixation. The curing process is in general carried out at a temperature which may be higher than the drying temperature. Preferred temperatures for curing are 60 to 170° C., preferably 70 to 170° C., more preferably 80 to 150° C. Drying and curing can be advantageously be performed during one single process, e.g. in stenters with different compartments which can be heated to different temperatures. If a reactive crosslinking agent is used temperatures may be lower, e.g. 30 to 130° C., preferably 30 to 100° C.

The drying and/or curing may for example be achieved in any equipment usually applied in non-living mills for these purposes, such as stenters, loop dryers, hotflues, tumble dryers, pad steam machines etc. In one embodiment of the present invention, equipment for continuous drying and/or curing is applied. In another embodiment of the present invention, equipment for discontinuous (batch-wise) drying and/or curing is used. Such equipment may comprise rotary or tumble dryers used in professional laundries, combined laundry/dryers which may be heated to the treatment temperatures, e.g. jeans stone-wash. The treatment chemicals may be added as a liquid or be sprayed onto the netting material and then brought to a homogeneous distribution by rotating the wet material before or during drying/curing. The treatment liquor may be added in excess if it is possible to remove the excess liquor e.g. by centrifuging. A person skilled in the art will be aware that treatment times might be longer than in the continuous process at the same temperature.

The curing process may also include or consist of passing the non-living material, for example the textile material or plastics material, by a heated surface under pressure such as an iron or a heated roller. During drying processes and curing the non-living material is preferably mechanically fixated in a way to prevent change of the form e.g. shrinkage or dimensional deformation. Further, it is prevented that the N-arylhydrazine derivative is washed out. The curing and/or fixation may be alternatively carried out by a dual-cure process combining heat and UV-light or only by UV-light. Suitable processes are known by a person skilled in the art.

The polymeric binder may advantageously be applied with a fixative agent for improved attachment of the N-arylhydrazine derivative on the non-living material. The fixative agent may comprise free isocyanate groups.

Suitable fixative agents are for example isocyanates or isocyanurates comprising free isocyanate groups. Preferably the isocyanurates are based on alkylene diisocyanates having from 4 to 12 carbon atoms in the alkylene unit, like 1,12-dodecane diisocyanate, 2-ethyltetramethylene diisocyanate-1,4,2-methylpentamethylene diisocyanate-1,5, tetramethylene diisocyanate-1,4, lysinester diisocyanate (LDI), hexamethylene diisocyanate-1,6 (HMDI), cyclohexane-1,3- and/or -1,4-diisocyanate, 2,4- and 2,6-hexahydro-toluoylene diisocyanate as well as the corresponding isomeric mixtures 4,4′-2,2′- and 2,4′-dicyclohexylmethane diisocyanate as well as the corresponding mixtures, 1-isocyanato-3,3,5-trimethyl-5-isocyanatomethyl cyclohexane (IPDI), 2,4- and/or 2,6-toluoylene diisocyanate, 4,4′-, 2,4′ and/or 2,2′-diphenylmethane diisocyanate (monomeric MDI), polyphenylpolymethylene polyisocyanate (polymeric MDI) and/or mixtures comprising at least 2 of the isocyanates mentioned before. More preferably the isocyanurates are based on hexamethylene diisocyanate-1,6 (HMDI).

More preferably the isocyanurate is a isocyanurate which is hydrophilized with a polyalkylene oxide based on ethylene oxide and/or 1,2-propylene oxide, preferably polyethylene oxide.

The isocyanurate used as fixative agent can be prepared by methods known in the art. Preferably 5 to 25% by weight, more preferably 7 to 20% by weight, most preferably to 15% by weight of the isocyanate groups based on the amount of isocyanate used as staring material for the preparation of the isocyanurate are free isocyanate groups.

Most preferably the isocyanurate used as fixative agent is dissolved in a polar aprotic solvent, e.g. THF, DMF or propylene or ethylene carbonate.

The most preferred fixative agent used is an isocyanurate based on HMDI which are hydrophilized with a polyethylene oxide and which is dissolved in propylene carbonate (70% by weight of HMDI in 30% by weight of propylene carbonate). The amount of free isocyanate groups is 11 to 12% by weight, based on the amount of isocyanate used as staring material for the preparation of the isocyanurate.

The insecticide composition preferably comprises the following components, based on the solids content of the composition, if a fixative agent is used:
a) 20 to 70% by weight, preferably 25 to 65% by weight, more preferably 30 to 65% by weight of at least one N-arylhydrazine derivative of formula I (component A), and
b) 29 to 72% by weight, preferably 34 to 70% by weight, more preferably 33 to 66 by weight of at least one polymeric binder (component B) as defined above
c) 1 to 8% by weight, preferably 1 to 5% by weight, more preferably 2 to 4% by weight of at least one fixative agent (component C);
   wherein the sum of the components is 100% by weight of solids content of the insecticide composition.

Preferred fixative agents are mentioned before.

As described above, the solution or emulsion may further comprise one or more components selected from water, preservatives, detergents, fillers, impact modifiers, anti-fogging agents, blowing agents, clarifiers, nucleating agents, coupling agents, conductivity-enhancing agents (antistats), stabilizers such as anti-oxidants, carbon and oxygen radical scavengers and peroxide decomposing agents and the like, flame retardants, mould release agents, agents having UV protecting properties, spreading agents, anti-blocking agents, anti-migrating agents, foam-forming agents, anti-soiling agents, thickeners, further biocides, wetting agents, plasticizers, adhesive or anti-adhesive agents, optical brightening (fluorescent whitening) agents, fragrance, pigments and dyestuffs.

The process may also involve using the kit as described before, accordingly, the impregnation process may be carried out by the end-user in a low-scale process or in a local factory. The present invention therefore relates to a process for impregnating a non-living material as described before, wherein the impregnating composition is provided as a kit for impregnation by the end-user or in a local factory.

In a further embodiment of the present invention the impregnation process which comprises applying an insecticide composition as described before may also take place before the non-living material is further processed, for example fibers are woven or knitted.

In a further embodiment the invention relates to a process for coating a non-living material by applying a composition comprising at least one N-arylhydrazine derivative of formula I and at least one polymeric binder as defined in the present invention to the non-living material. The coating is preferably carried out in a doctor-blade process. The process conditions are known by a person skilled in the art.

Preferred compositions for coating a non-living material and preferred further ingredients of the composition are already mentioned above.

In a further embodiment the present invention relates to the use of an insecticide composition of the present invention for impregnation of a non-living material. Preferred insecticide compositions as well as preferred non-living materials are mentioned before. Most preferably the non-living material is a netting made from or comprising as the main component polyester, preferably polyethylene terephthalate.

### EXAMPLES

### Binder

### Example A

### A) Preparation of Polymer Dispersions

### General Procedure:

250 g of water and 3 g of a styrene seed (33% by weight) having a medium particle diameter of 30 nm are heated to 85° C. and 5% by weight of feed 2 are added. After 10 min. addition of feed 1 comprising the monomers mentioned below and feed 2 is started.

Feed 2 comprises 3.0 g sodiumperoxidsulfate dissolved in 39.9 g of water.

The composition of feed 1 is listed in table 1.

Feed 1 and 2 are added in 3 h, and it was polymerized for further 0.5 h.

TABLE 1
Composition of feed 1 in % by weight pphm (parts per hundred monomers)

| Monomer | | | | | | | | | | | | | | BMA- |
|---|---|---|---|---|---|---|---|---|---|---|---|---|---|---|
| compositions | MMA | S | AN | EHA | BA | EA | HPMA | GMA | MaMol | AMol | AM | AS | FI-1 | Acac |
| A 1 | 27.0 | | | 3.1 | 65.0 | | | | | | 2.0 | 1.0 | 1.9 | |
| A 2 | 23.9 | 5.0 | | 5.3 | 60.0 | | | | | | 1.2 | 0.6 | | 4.0 |
| A 3 | | 16.6 | | 30.0 | 30.0 | 20.0 | | | | 3.0 | | 0.4 | | |
| A 4 | 25.7 | 5.0 | | 5.3 | 60.0 | | | | 3.5 | | | 0.5 | | |
| A 5 | | 14.7 | 11.0 | | 70.0 | | | | 3.5 | | 0.5 | 0.3 | | |
| A 6 | 30.0 | 13.0 | 8.0 | | 45.2 | | | | | 3.0 | 0.5 | 0.3 | | |
| A 7 | 30.0 | 13.0 | 8.0 | | 44.5 | | | | | | 0.5 | 0.3 | | 3.7 |
| A 8 | 33.0 | | | | 60.0 | 3.9 | | | | | 1.0 | 0.5 | 1.6 | |
| A 9 | 20.0 | 20.0 | | 17.0 | 23.0 | 15.3 | | | 3.5 | | | 1.2 | | |
| A 10 | 20.0 | 20.0 | | 17.0 | 23.0 | 15.3 | | | | | 0.4 | 0.3 | | 4.0 |
| A 11 | 10.0 | 10.0 | | | 25.5 | 50.0 | 2.5 | | | | | 2.0 | | |
| A 12 | 10.0 | 10.0 | | | 25.5 | 47.7 | 2.5 | 3.5 | | | 0.7 | 0.1 | | |
| A 13 | | 10.0 | 11.0 | | 60.0 | 14.7 | | 4.0 | | | 0.2 | 0.1 | | |
| A 14 | | 20.0 | 8.0 | | 55.0 | 12.5 | 3.0 | | | | | 1.5 | | |
| A 15 | 26.0 | | 13.0 | | 57.0 | | | | 3.0 | | | 1.0 | | |
| A 16 | 15.0 | | 13.0 | | 68.0 | | | | 3.0 | | | 1.0 | | |
| A 17 | | | 16.0 | | 81.0 | | | | 2.0 | | | 1.0 | | |

The amount of initiator sodium peroxidisulfate is 0.3 parts by weight, the emulsifier comprises 0.4 parts by weight of Dowfax 2A1 (Dow) under 0.6 parts by weight of Lumiten IRA (BASF AG), relating to 100 parts by weight of the monomer composition of table 1.

### Abbreviations:

MMA: methyl methacrylate
S: styrene
AN: acrylic nitril
EA: ethyl acrylate
EHA: 2-ethylhexylacrylate
BA: n-butyl acrylate
FI: copolymerizable benzophenone having an acrylic group
GMA: glycidylmethacrylate
BMA-Acac: bitandiolmonoacrylate acetylacetate
Amol: N-methylol acrylamide
MAMol: N-methylol methacrylamide
HPMA: hydroxypropyl methacrylate
AS: acrylic acid
AM: acrylic amide

### Dowfax 2A1:

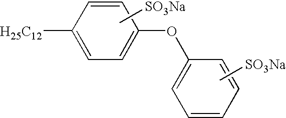

### Lumiten IRA:

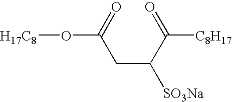

### Examples A1 and A8

Aqueous polymer dispersions comprising FI-1 polymerizable photo initiator which is later useful as crosslinking agent is a photo initiator of formula

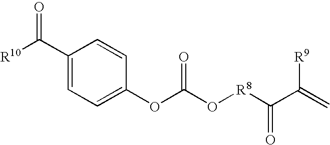

wherein
R⁸ is an organic radical having from 1 to 30 carbon atoms,
R⁹ is H or a methyl group, and
R¹⁰ is a phenyl group which is optionally substituted or a C₁- to C₄-alkyl group.

### Examples of Use

### Example B

The long-lasting insecticidal treatment was performed with aqueous dispersions according to examples A1-A17 on commercially available white polyester netting material (fiber titer 75 denier, 156 mesh, weight 28-32 g/m²) without prior washing. The aqueous treatment baths were prepared by mixing the aqueous dispersions with emulsions of N-ethyl-2,2-dimethylpropionamide-2-(2,6-dichloro-α,α,α-trifluoro-p-tolyl)-hydrazone and N-ethyl-2,2-dichloro-1-methylcyclo-propanecarboxamide-2-(2,6-dichloro-α,α,α-tri-fluoro-p-tolyl)hydrazone, respectively, setting pH with buffer solutions and adding a fixative (if needed). The concentrations of the treatment baths were adjusted according to the liquor uptake possible (LU between 60 and 100%). The treatment baths were applied by using a padder-stenter equipment on a laboratory scale (Mathis AG, Switzerland). The netting material is fully immersed into the treatment bath and excess liquor is removed by passing it through cylinders which move in counter-direction. By choosing a defined distance between these cylinders (and thus a defined pressure) the liquor uptake can be controlled. The liquor uptake is measured by weighing an impregnated piece of netting and subtracting the weight of the dry, untreated netting and is given as % weight of liquor on weight of netting. The drying/curing step was performed in a laboratory stenter which allows to control the temperature and time of the treatment.

The treated nettings have been washed different times. The washing was carried out by the “Montpellier washing procedure” (as described in the annex WHO PVC, Mar. 7, 2002“Evaluation of wash resistance of long-lasting insecticidal nets”): Net samples are washed individually in beakers containing 0.5 L deionised water and 2 g/L soap (pH 10-11) at 30° C. in a water bath shaken for 10 minutes in clean water at 155 movements per minute. The soap used comprises (among further components like etidronic acid and sodium hydroxide or coconut acid, tetra sodium EDTA and limonene) the following ingredients: Sodium tallowate, water, sodium palm kernelate or sodium cocoate, perfume, glycerol, sodium chloride and some dyestuff (C.I. 77891).

Samples were bioassayed according to the cone testing procedure described below.

### Testing Procedure:

The testing follows the basic guidelines of WHO cone testing procedures with a few modifications. Cones (WHO cones (WHOPES 96.1): clear plastic cone structures (11 cm diam.) with a flat flange around the bottom edge and a hole at the apex) are held against treated net pieces (25×25 cm) via a hand-made manifold apparatus modeled similarly to CDC (Centers for Disease Control and Prevention) methodology. The manifold device used is made by cutting four holes (9 cm diameter) in a plastic serving tray (30.5×41.0 cm, Consolidated Plastics). An unmodified tray of the same dimensions acts as a base. Onto the surface of the base tray two pieces of blotter paper are placed, cut to fit inside the tray. A piece of treated netting is then placed onto the blotter paper followed by four WHO cones placed to roughly correspond to the positioning of the holes cut in the manifold (top) tray. This top tray is then placed over the cones so they pass through the holes. The top tray is then securely fastened to the base tray using four large binder clips. The blotter paper helps to ensure a reasonably tight fit of the cones to the netting. Mixed sex mosquitoes, 1-5 days old, are removed from a rearing cage with an aspirator and ca. 5 mosquitoes placed into each cone. A lab timer is started after the introduction of insects into the first cone with each cone supplied with mosquitoes ca. 15 seconds apart, taking one minute to fill all the cones. Each cone is plugged with a rubber stopper immediately after introduction of the insects. Mosquitoes are held in each cone for three minutes where each insect typically rests on the netting surface (if treatment is not strongly repellent). If any mosquito rests on the wall of a cone then the cone can be tapped gently to relocate the insect to the netting. After three minutes, the insects are all removed by aspirator and placed into a plastic holding cup, combining mosquitoes from all four cones, which represent a single replicate. Four replicates of each treatment are recommended. The holding cup consists of a clear plastic cup (9 cm tall×6.5 cm wide) with a plastic screw-on lid. A 1 cm hole in the lid is used to insert the aspirator for insect deposition. One set of mosquitoes from each cone is collected and deposited into the holding container at a time. Between insertions of the aspirator tip into the container lid, an overhead transparency marker is used to plug the hole to prevent insect escape. After all four cones have been emptied of insects into the holding container, the hole is then plugged with a cotton dental wick soaked with 10% sugar water. The end of the wick sticking out of the cup should have the end manually flattened somewhat to ensure that it doesn't fall into the cup and allow mosquito escape. Knockdown (KD) data are generally taken from the pooled mosquitoes at 60 minutes and 24-hours. A 30-minute (or other) reading can be included if deemed necessary. For speed of knockdown, the mosquito can be left in the cone and the time to KD recorded for each individual mosquito. Each KD mosquito is removed as it goes down to prevent recounting that insect if it once again flies. All mosquitoes are then held as described previously for a 24-hour Mortality count.

### RESULTS

The nettings treated with an insecticide composition comprising a binder of example A and a N-arylhydrazine derivative of formula Ia-I or Ia-II show an activity (knockdown, mortality) after washing of the nettings.

1-24. (canceled)

25. An insecticide composition for application to a non-living material, the insecticide composition comprising a mixture of:
a) at least one N-arylhydrazine derivative of formula I, as component A: 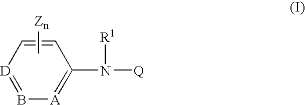
wherein
A is C—R² or N;
B is C—R³ or N;
D is C—R⁴ or N;
with the proviso that at least one of A, B, or D must be other than N;
Z is halogen, CN, NO₂, C₁-C₆-alkyl, C₁-C₆-haloalkyl, C₁-C₆-alkoxy, or C₁-C₆-haloalkoxy;
n is an integer of 0, 1, or 2;
Q is 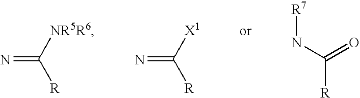
wherein
R is:
hydrogen;
C₁-C₁₀-alkyl, optionally substituted with one or more halogens; C₃-C₆-cycloalkyl;
C₁-C₄-alkoxy; C₁-C₄-haloalkoxy; (C₁-C₄-alkyl)SOₓ; (C₁-C₄-haloalkyl)SOₓ; phenyl, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂, or CN groups; phenoxy, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂, or CN groups;
C₃-C₁₂-cycloalkyl, optionally substituted with one or more halogens, C₁-C₆-alkyl, C₁-C₆-haloalkyl, C₁-C₄-alkoxy, C₁-C₄-haloalkoxy, (C₁-C₄-alkyl)SOₓ, (C₁-C₄-haloalkyl)SOₓ;
or
CR¹⁷R¹⁸R¹⁹;
R¹⁷ and R¹⁸ are each independently: C₁-C₆-alkyl, C₃-C₆-alkenyl, C₃-C₆-alkynyl, or C₃-C₆-cycloalkyl which may be substituted with 1 to 3 halogen atoms;
R¹⁹ is hydrogen or C₁-C₆-alkyl;
R¹ and R⁷ are each independently hydrogen or C₁-C₄-alkyl;
R⁵ and R⁶ are each independently:
hydrogen;
C₁-C₁₀-alkyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups; C₃-C₁₀-alkenyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups;
C₃-C₁₀-alkynyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups; C₃-C₁₂-cycloalkyl, optionally substituted with one or more halogen, hydroxy, C₁-C₄alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups;
R⁵ and R⁶ may be taken together to form a ring represented by the structure 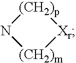
R², R³ and R⁴ are each independently hydrogen, halogen, CN, NO₂, (C₁-C₄-alkyl)SOₓ, (C₁-C₄-haloalkyl)SOₓ, C₁-C₆-alkyl, C₁-C₆-haloalkyl, C₁-C₆-alkoxy, or C₁-C₆-haloalkoxy;
R⁸, R⁹ and R¹⁰ are each independently hydrogen or C₁-C₄-alkyl;
R¹¹ is NR¹³R¹⁴, 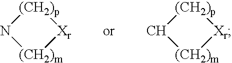
R¹² is 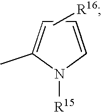
R¹³, R¹⁴, R¹⁵ and R¹⁶ are each independently hydrogen or C₁-C₄-alkyl;
X is O, S or NR¹⁵;
X¹ is chlorine, bromine or fluorine;
r is an integer of 0 or 1;
p and m are each independently an integer of 0, 1, 2, or 3, with the proviso that only one of p, m or r can be 0 and with the further proviso that the sum of p+m+r must be 4, 5, or 6;
x is an integer of 0, 1, or 2; or
enantiomers or the salts thereof;
and
b) at least one polymeric binder, as component B.

26. The insecticide composition of claim 25, wherein
Q is

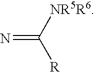

27. The insecticide composition of claim 25, wherein the arylhydrazine derivative is a compound of formula Ia-A: 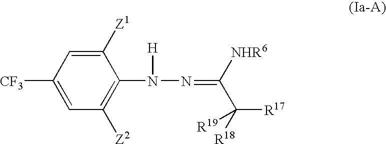
wherein
R⁴ is chlorine or trifluoromethyl;
Z¹ and Z² are each independently chlorine or bromine;
R⁶ is C₁-C₆-alkyl, C₃-C₆-alkenyl, C₃-C₆-alkynyl, or C₃-C₆-cycloalkyl which may be substituted with 1 to 3 halogen atoms, or C₂-C₄-alkyl which is substituted by C₁-C₄-alkoxy;
R¹⁷ and R¹⁸ are each independently C₁-C₆-alkyl, C₃-C₆-alkenyl, C₃-C₆-alkynyl, or C₃-C₆-cycloalkyl which may be substituted with 1 to 3 halogen atoms;
R¹⁹ is hydrogen or C₁-C₆-alkyl;
or enantiomers or salts thereof.

28. The insecticide composition of claim 25, wherein the at least one polymeric binder is a homopolymer or copolymer selected from the group consisting of polyacrylate, polymethacrylate, polyacrylonitrile, polymaleic acid anhydride, polystyrene, poly(methyl)styrene, polybutadiene, polyvinylacetate, polyvinylalcohol, and blends of said homopolymers and/or copolymers; polyurethane, polyisocyanurate, polyurethane and/or polyisocyanurate blends, mineral waxes, zirconium waxes, silicones, polysiloxanes, fluorocarbon resin, melamine formaldehyde condensation resin, methylol urea derivative, curable polyester, and blends or preparations thereof.

29. The insecticide composition of claim 28 wherein the at least one polymer binder is selected from the group consisting of:
b1) an acrylic binder B1, said acrylic binder prepared by the process of radical polymerization of the following components:
b1a) at least one monomer B1A of formula II: 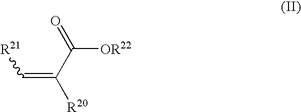
wherein
R²⁰, R²¹ and R²² are independently selected from C₁- to C₁₀-alkyl which may be linear or branched; substituted or unsubstituted aryl;
R²⁰ and R²¹ may further be H;
b1b) at least one monomer B1B of formula III: 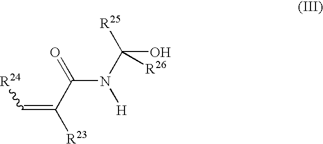
wherein
R²³, R²⁴, R²⁵ and R²⁶ are independently selected from the group consisting of H, C₁- to C₁₀-alkyl which may be linear or branched; substituted or unsubstituted aryl;
b1c) optionally at least one monomer B1C of formula IV: 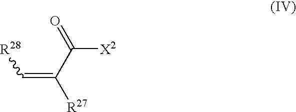
wherein
R²⁷ and R²⁸ are independently selected from the group consisting of H, C₁- to C₁₀-alkyl which may be linear or branched; substituted or unsubstituted aryl;
X² is selected from the group consisting of H, OH, NH₂, OR³⁰OH, glycidyl, hydroxypropyl, 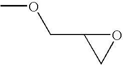
groups of the formula 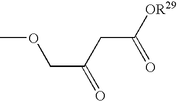
wherein
R²⁹ is selected from the group consisting of C₁- to C₁₀-alkyl which may be branched or linear; substituted or unsubstituted aryl;
R³⁰ is selected from the group consisting of C₁- to C₁₀-alkylene; substituted or unsubstituted arylenes;
b1d) further monomers which are copolymerizable with the monomers mentioned above selected from the group consisting of:
b1d1) polar monomers as component B1D1;
and/or
b1d2) non polar monomers as component B1D2;
and/or
b2) at least one polyurethane and/or polyisocyanurate binder B2, wherein said polyurethane is prepared by reaction of:
b2a) at least one diisocyanate or polyisocyanate B2A;
b2b) at least one diol, triol or polyol B2B;
b2c) optionally components B2C; and
b2d) optionally additives B2D;
and mixtures of B1 and B2.

30. The insecticide composition of claim 29, wherein the at least one polymeric binder is selected from the group consisting of:
an acrylic binder, said acrylic binder is prepared by the process of emulsion polymerization of the following components:
b1a) 10 to 95% by weight of B1A;
b1b) 1 to 5% by weight of B1B;
b1c) 0 to 5% by weight of B1C;
bid) 0 to 30% by weight of B1D1; and/or
0 to 40% by weight of B1D2;
wherein the sum of the components B1A, B1B and optionally B1C and B1D1 and/or B1D2 is 100% by weight;
and/or
at least one polyurethane and/or polyisocyanurate binder, wherein said polyurethane is prepared by the reaction of the following components:
b2a) 55 to 90% by weight based on the polyurethane of component B2a;
b2b) 10 to 45% by weight based on the polyurethane of component B2B;
b2c) 0 to 10% by weight based on the polyurethane of component B2C; and
b2d) 0 to 10% by weight based on the polyurethane of component B2D;
wherein the sum of the components B2A, B2B, B2C and B2D is 100% by weight.

31. The insecticide composition of claim 25, further comprising one or more components selected from water, preservatives, detergents, stabilizers, agents having UV-protecting properties, optical brighteners, spreading agents, anti-migrating agents, foam forming agents, wetting agents, anti-soiling agents, thickeners, further biozides, plasticizers, adhesive agents, pigments and dyestuffs.

32. The insecticide composition of claim 25 comprising from about 0.001 to 95% by weight of the at least one N-arylhydrazine derivative of formula I.

33. The insecticide composition of claim 25 which is provided as a kit for impregnation by the end-user.

34. The insecticide composition of claim 33 wherein the composition in the kit is adapted for preparing a solution or emulsion by adding water.

35. An impregnated non-living material for public health pest control comprising:
a) at least one N-arylhydrazine derivative of formula I: 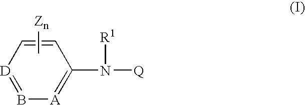
wherein
A is C—R² or N;
B is C—R³ or N;
D is C—R⁴ or N;
with the proviso that at least one of A, B, or D must be other than N;
Z is halogen, CN, NO₂, C₁-C₆-alkyl, C₁-C₆-haloalkyl, C₁-C₆-alkoxy, or C₁-C₆-haloalkoxy;
n is an integer of 0, 1, or 2;
Q is 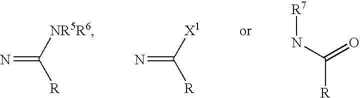
wherein
R is:
hydrogen;
C₁-C₁₀-alkyl, optionally substituted with one or more halogens; C₃-C₆-cycloalkyl;
C₁-C₄-alkoxy; C₁-C₄-haloalkoxy; (C₁-C₄-alkyl)SOₓ; (C₁-C₄-haloalkyl)SOₓ;
phenyl, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂, or CN groups; phenoxy, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂, or CN groups;
C₃-C₁₂-cycloalkyl, optionally substituted with one or more halogens, C₁-C₆-alkyl, C₁-C₆-haloalkyl, C₁-C₄-alkoxy, C₁-C₄-haloalkoxy, (C₁-C₄-alkyl)SOₓ, (C₁-C₄-haloalkyl)SOₓ;
or
CR¹⁷R¹⁸R¹⁹;
R¹⁷ and R¹⁸ are each independently: C₁-C₆-alkyl, C₃-C₆-alkenyl, C₃-C₆-alkynyl, or C₃-C₆-cycloalkyl which may be substituted with 1 to 3 halogen atoms;
R¹⁹ is hydrogen or C₁-C₆-alkyl;
R¹ and R⁷ are each independently hydrogen or C₁-C₄-alkyl;
R⁵ and R⁶ are each independently:
C₁-C₁₀-alkyl, optionally substituted with one or more halogen, hydroxy, C₁-C₄alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups; C₃-C₁₀-alkenyl, optionally substituted with one or more halogen, hydroxy, C₁-C₄-alkoxy, (C₁-C₄alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups;
C₃-C₁₀-alkynyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl,
C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups; C₃-C₁₂-cycloalkyl, optionally substituted with one or more halogen, hydroxy, C₁-C₄alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups;
R⁵ and R⁶ may be taken together to form a ring represented by the structure 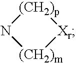
R², R³ and R⁴ are each independently hydrogen, halogen, CN, NO₂, (C₁-C₄-alkyl)SOₓ, (C₁-C₄-haloalkyl)SOₓ, C₁-C₆-alkyl, C₁-C₆-haloalkyl, C₁-C₆-alkoxy, or C₁-C₆-haloalkoxy;
R⁸, R⁹ and R¹⁰ are each independently hydrogen or C₁-C₄-alkyl;
R¹¹ is NR¹³R¹⁴, 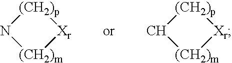
R¹² is 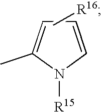
R¹³, R¹⁴, R¹⁵ and R¹⁶ are each independently hydrogen or C₁-C₄-alkyl;
X is O, S or NR¹⁵;
X¹ is chlorine, bromine or fluorine;
r is an integer of 0 or 1;
p and m are each independently an integer of 0, 1, 2, or 3, with the proviso that only one of p, m or r can be 0 and with the further proviso that the sum of p+m+r must be 4, 5, or 6;
x is an integer of 0, 1, or 2; or
enantiomers or the salts thereof;
and
b) at least one polymeric binder.

36. The impregnated non-living material of claim 35, wherein the polymeric binder is a homopolymer or copolymer selected from the group consisting of polyacrylate, polymethacrylate, polyacrylonitrile, polymaleic acid anhydride, polystyrene, poly(methyl)styrene, polybutadiene, polyvinylacetate, polyvinylalcohol, and blends of said homopolymers and/or copolymers; polyurethane, polyisocyanurate, polyurethane and/or polyisocyanurate blends, mineral waxes, zirconium waxes, silicones, polysiloxanes, fluorocarbon resin, melamine formaldehyde condensation resin, methylol urea derivative, curable polyester, or blends or preparations thereof.

37. The impregnated non-living material of claim 35, further comprising one or more components selected from preservatives, detergents, stabilizers, agents having UV-protecting properties, optical brighteners, spreading agents, anti-migrating agents, foam-forming agents, wetting agents, anti-soiling agents, thickeners, further biocides, plasticizers, adhesive agents, pigments, and dyestuffs.

38. The impregnated non-living material of claim 35 comprising from about 0.001 to 10% by weight of the weight of the non-living material of at least one N-arylhydrazine derivative of formula I.

39. The impregnated non-living material of claim 35, wherein the non-living material is a netting made from polyester.

40. A process for impregnation of a non-living material comprising the steps of:
i) forming an aqueous formulation comprising at least one N-arylhydrazine derivative of formula I: 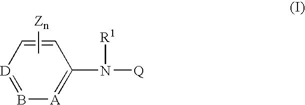
wherein
A is C—R² or N;
B is C—R³ or N;
D is C—R⁴ or N;
with the proviso that at least one of A, B, or D must be other than N;
Z is halogen, CN, NO₂, C₁-C₆-alkyl, C₁-C₆-haloalkyl, C₁-C₆-alkoxy, or C₁-C₆-haloalkoxy;
n is an integer of 0, 1, or 2;
Q is 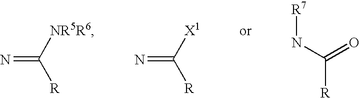
wherein
R is:
hydrogen;
C₁-C₁₀-alkyl, optionally substituted with one or more halogens; C₃-C₆-cycloalkyl;
C₁-C₄-alkoxy; C₁-C₄-haloalkoxy; (C₁-C₄-alkyl)SOₓ; (C₁-C₄-haloalkyl)SOₓ;
phenyl, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂, or CN groups; phenoxy, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂, or CN groups;
C₃-C₁₂-cycloalkyl, optionally substituted with one or more halogens, C₁-C₆-alkyl, C₁-C₆-haloalkyl, C₁-C₄-alkoxy, C₁-C₄-haloalkoxy, (C₁-C₄-alkyl)SOₓ, (C₁-C₄-haloalkyl)SOₓ;
or
CR¹⁷R¹⁸R¹⁹;
R¹⁷ and R¹⁸ are each independently: C₁-C₆-alkyl, C₃-C₆-alkenyl, C₃-C₆-alkynyl, or C₃-C₆-cycloalkyl which may be substituted with 1 to 3 halogen atoms;
R¹⁹ is hydrogen or C₁-C₆-alkyl;
R¹ and R⁷ are each independently hydrogen or C₁-C₄-alkyl;
R⁵ and R⁶ are each independently:
hydrogen;
C₁-C₁₀-alkyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups; C₃-C₁₀-alkenyl, optionally substituted with one or more halogen, hydroxy, C₁-C₄-alkoxy, (C₁-C₄alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups;
C₃-C₁₀-alkynyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups; C₃-C₁₂-cycloalkyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups;
R⁵ and R⁶ may be taken together to form a ring represented by the structure 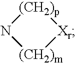
R², R³ and R⁴ are each independently hydrogen, halogen, CN, NO₂, (C₁-C₄-alkyl)SOₓ, (C₁-C₄-haloalkyl)SOₓ, C₁-C₆-alkyl, C₁-C₆-haloalkyl, C₁-C₆-alkoxy, or C₁-C₆-haloalkoxy;
R⁸, R⁹ and R¹⁰ are each independently hydrogen or C₁-C₄-alkyl;
R¹¹ is NR¹³R¹⁴, 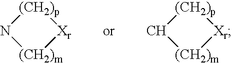
R¹² is 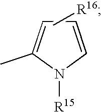
R¹³, R¹⁴, R¹⁵ and R¹⁶ are each independently hydrogen or C₁-C₄-alkyl;
X is O, S or NR¹⁵;
X¹ is chlorine, bromine or fluorine;
r is an integer of 0 or 1;
p and m are each independently an integer of 0, 1, 2, or 3, with the proviso that only one of p, m or r can be 0 and with the further proviso that the sum of p+m+r must be 4, 5, or 6;
x is an integer of 0, 1, or 2; or
enantiomers or the salts thereof;
and
at least one polymeric binder; and optionally further ingredients;
ii) applying the aqueous formulation to the non-living material by
iia) passing the non-living material through the aqueous formulation;
or
iib) bringing the non-living material into contact with a roller that is partly or fully dipped into the aqueous formulation and drawing the aqueous formulation to the side of the non-living material in contact with the roller;
or
iic) double-side coating of the non-living material;
or
iid) spraying the aqueous formulation onto the non-living material;
or
iie) applying the aqueous formulation in form of a foam;
or
iif) submerging the non-living material into the aqueous formulation;
or
iig) brushing the aqueous formulation onto or into the non-living material;
or
iih) pouring the aqueous formulation onto the non-living material;
iii) optionally removing surplus aqueous formulation; and
iv) drying and/or curing the non-living material.

41. The process of claim 40, wherein step iia) is carried out by completely submerging the non-living material in the aqueous formulation either in a trough containing the aqueous formulation or passing the non-living material through the aqueous formulation which is held between two horizontally oriented rollers.

42. The process of claim 40, wherein the aqueous formulation further comprises one or more ingredients selected from the group consisting of detergents, stabilizers, agents having UV-protecting properties, optical brighteners, spreading agents, anti-migrating agents, preservatives, foam-forming agents, wetting agents, thickeners, further biozides, plasticizers, adhesive agents, anti-soiling agents, pigments and dyestuffs.

43. The process of claim 40 wherein the impregnating composition is provided as a kit.

44. The process of claim 40, wherein the dying of the non-living material is carried out simultaneously with the impregnation of the non-living material, wherein an aqueous formulation is formed further comprising at least one dyestuff and/or at least one pigment.

45. A process for coating a non-living material comprising:
a) applying to the non-living material a composition comprising:
at least one N-arylhydrazine derivative of formula I: 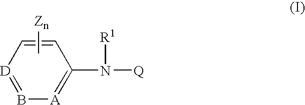
wherein
A is C—R² or N;
B is C—R³ or N;
D is C—R⁴ or N;
D is C—R⁴ or N;
with the proviso that at least one of A, B, or D must be other than N;
Z is halogen, CN, NO₂, C₁-C₆-alkyl, C₁-C₆-haloalkyl, C₁-C₆-alkoxy, or C₁-C₆-haloalkoxy;
n is an integer of 0, 1, or 2;
Q is 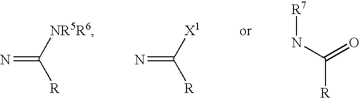
wherein
R is:
hydrogen;
C₁-C₁₀-alkyl, optionally substituted with one or more halogens; C₃-C₆-cycloalkyl;
C₁-C₄-alkoxy; C₁-C₄-haloalkoxy; (C₁-C₄-alkyl)SOₓ; (C₁-C₄-haloalkyl)SOₓ;
phenyl, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂, or CN groups; phenoxy, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂, or CN groups;
C₃-C₁₂-cycloalkyl, optionally substituted with one or more halogens, C₁-C₆-alkyl, C₁-C₆-haloalkyl, C₁-C₄-alkoxy, C₁-C₄-haloalkoxy, (C₁-C₄-alkyl)SOₓ, (C₁-C₄-haloalkyl)SOₓ;
or
CR¹⁷R¹⁸R¹⁹;
R¹⁷ and R¹⁸ are each independently: C₁-C₆-alkyl, C₃-C₆-alkenyl, C₃-C₆-alkynyl, or C₃-C₆-cycloalkyl which may be substituted with 1 to 3 halogen atoms;
R¹⁹ is hydrogen or C₁-C₆-alkyl;
R¹ and R⁷ are each independently hydrogen or C₁-C₄-alkyl;
R⁵ and R⁶ are each independently:
hydrogen;
C₁-C₁₀-alkyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups; C₃-C₁₀-alkenyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups;
C₃-C₁₀-alkynyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups; C₃-C₁₂-cycloalkyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups;
R⁵ and R⁶ may be taken together to form a ring represented by the structure 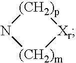
R², R³ and R⁴ are each independently hydrogen, halogen, CN, NO₂, (C₁-C₄-alkyl)SOₓ, (C₁-C₄-haloalkyl)SOₓ, C₁-C₆-alkyl, C₁-C₆-haloalkyl, C₁-C₆-alkoxy, or C₁-C₆-haloalkoxy;
R⁸, R⁹ and R¹⁰ are each independently hydrogen or C₁-C₄-alkyl;
R¹¹ is NR¹³R¹⁴, 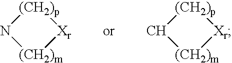
R¹² is 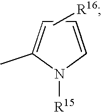
R¹³, R¹⁴, R¹⁵ and R¹⁶ are each independently hydrogen or C₁-C₄-alkyl;
X is O, S or NR¹⁵;
X¹ is chlorine, bromine or fluorine;
r is an integer of 0 or 1;
p and m are each independently an integer of 0, 1, 2, or 3, with the proviso that only one of p, m or r can be 0 and with the further proviso that the sum of p+m+r must be 4, 5, or 6;
x is an integer of 0, 1, or 2; or
enantiomers or the salts thereof;
and
b) at least one polymeric binder;
wherein the non-living material is coated.

46. The process of claim 45, wherein the composition further comprises one or more ingredients selected from the group consisting of detergents, stabilizers, agents having UV-protecting properties, optical brighteners, spreading agents, anti-migrating agents, preservatives, foam-forming agents, anti-soiling agents, wetting agents, thickeners, further biozides, plasticizers, adhesive agents, pigments and dyestuffs.

47. A method for impregnation of a non-living material comprising the step of applying an insecticide composition of:
a) at least one N-arylhydrazine derivative of formula I, as component A: 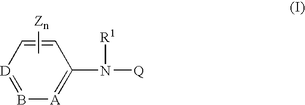
wherein
A is C—R² or N;
B is C—R³ or N;
D is C—R⁴ or N;
with the proviso that at least one of A, B, or D must be other than N;
Z is halogen, CN, NO₂, C₁-C₆-alkyl, C₁-C₆-haloalkyl, C₁-C₆-alkoxy, or C₁-C₆-haloalkoxy;
n is an integer of 0, 1, or 2;
Q is 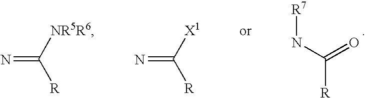
wherein
R is:
hydrogen;
C₁-C₁₀-alkyl, optionally substituted with one or more halogens; C₃-C₆-cycloalkyl;
C₁-C₄-alkoxy; C₁-C₄-haloalkoxy; (C₁-C₄-alkyl)SOₓ; (C₁-C₄-haloalkyl)SOₓ;
phenyl, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂, or CN groups; phenoxy, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂, or CN groups;
C₃-C₁₂-cycloalkyl, optionally substituted with one or more halogens, C₁-C₆-alkyl, C₁-C₆-haloalkyl, C₁-C₄-alkoxy, C₁-C₄-haloalkoxy, (C₁-C₄-alkyl)SOₓ, (C₁-C₄-haloalkyl)SOₓ;
or
CR¹⁷R¹⁸R¹⁹;
R¹⁷ and R¹⁸ are each independently: C₁-C₆-alkyl, C₃-C₆-alkenyl, C₃-C₆-alkynyl, or C₃-C₆-cycloalkyl which may be substituted with 1 to 3 halogen atoms;
R¹⁹ is hydrogen or C₁-C₆-alkyl;
R¹ and R⁷ are each independently hydrogen or C₁-C₄-alkyl;
R⁵ and R⁶ are each independently:
hydrogen;
C₁-C₁₀-alkyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups; C₃-C₁₀-alkenyl, optionally substituted with one or more halogen, hydroxy, C₁-C₄-alkoxy, (C₁-C₄alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups;
C₃-C₁₀-alkynyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups; C₃-C₁₂-cycloalkyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂, or CN groups;
phenyl, optionally substituted with one or more halogen, C₁-C₄-alkyl, C₁-C₄-haloalkyl, C₁-C₄-alkoxy, C₁-C₄-haloalkoxy, NO₂, or CN groups;
pyridyl, optionally substituted with one or more halogen, C₁-C₄-alkyl, C₁-C₄-haloalkyl, C₁-C₄-alkoxy, C₁-C₄-haloalkoxy, NO₂, or CN groups;
R⁵ and R⁶ may be taken together to form a ring represented by the structure 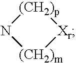
R², R³ and R⁴ are each independently hydrogen, halogen, CN, NO₂, (C₁-C₄-alkyl)SOₓ, (C₁-C₄-haloalkyl)SOₓ, C₁-C₆-alkyl, C₁-C₆-haloalkyl, C₁-C₆-alkoxy, or C₁-C₆-haloalkoxy;
R⁸, R⁹ and R¹⁰ are each independently hydrogen or C₁-C₄-alkyl;
R¹¹ is NR¹³R¹⁴, 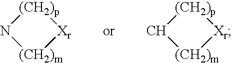
R¹² is 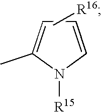
R¹³, R¹⁴, R¹⁵ and R¹⁶ are each independently hydrogen or C₁-C₄-alkyl;
X is O, S or NR¹⁵;
X¹ is chlorine, bromine or fluorine;
r is an integer of 0 or 1;
p and m are each independently an integer of 0, 1, 2, or 3, with the proviso that only one of p, m or r can be 0 and with the further proviso that the sum of p+m+r must be 4, 5, or 6;
x is an integer of 0, 1, or 2; or
enantiomers or the salts thereof;
and
b) at least one polymeric binder as component B;
wherein the non-living material is impregnated.

48. A method of claim 47, wherein the non-living material is a netting made from polyester.
